(19) United States
(12) Patent Application Publication
(10) Pub. No.: US 2010/0027398 A1
(43) Pub. Date: Feb. 4, 2010

(54) OPTICAL DISC DEVICE AND RECORDING DEVIATION AMOUNT TRANSFER METHOD

(76) Inventors: Takahiro Ichikura, Osaka (JP); Hideo Sakon, Osaka (JP); Yorikazu Takao, Osaka (JP); Daigo Senoo, Osaka (JP); Youichi Ogura, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/519,938

(22) PCT Filed: Dec. 20, 2007
(86) PCT No.: PCT/JP2007/074484

§ 371 Date: Jun. 18, 2009

(30) Foreign Application Priority Data
Dec. 21, 2006 (JP) 2006-343757

(51) Int. Cl. G11B 7/00

(52) U.S. Cl. 369/53.34; G9B/7

(57) ABSTRACT

There is provided an optical disc device which can evaluate in a short time as to whether an optical disc is recorded with satisfying the standard or not.

An optical disc device for measuring a recording deviation amount of data recorded on an optical disc on which physical addresses are previously provided, includes an address detection circuit which detects the physical address and outputs a physical address detection signal, a timer which is operated in synchronization with reproduced data from the optical disc, a recording deviation amount measurement circuit which measures the recording deviation amount of data recorded on the optical disc by using the physical address detection signal and the count value of the timer, a memory which stores the measured recording deviation amount, and a data transfer circuit which transfers the recording deviation amount to the memory.

### TECHNICAL FIELD

In recent years, a various kinds of optical disc devices for recording and reproducing data using light beams have been developed. Particularly, CD-R/RW, DVD-RAM, DVD-R/RW, DVD+R/RW, and the like have been developed as recordable optical discs.

In the case of DVD-R/RW, in order to specify a recording position, convex pits which are called land pre-pits are provided in land tracks on the right and left sides of groove tracks. Detection of a land pre-pit is performed by binarizing a push-pull signal with a predetermined slice level, which push-pull signal is obtained when a light beam is applied to a groove track.

Further, the tracks are waved at predetermined intervals to obtain a recording clock signal synchronized with the linear velocity of a rotating optical disc. This wave is called wobble. The wobble is arranged so as to maintain a predetermined phase relation with the land pre-pit. Detection of wobble is performed by binarizing the push-pull signal with a predetermined slice level as in the case of detecting the land pre-pit. By detecting the frequency of the wobble and performing predetermined multiplication to the frequency, a recording clock signal corresponding to the unit time length of a record mark can be obtained.

Recording of DVD-R/RW is generally performed in synchronization with the recording clock signal obtained from the wobble, based on the land prepit signal. At this time, when there is previously recorded data, a very-high-precision recording position control is required so as not to generate a discontinuity due to a gap or overwriting between the previously recorded data and newly recorded data.

However, the track pitch of the DVD-R/RW is 0.74 μm, which is small as less than half of the track pitch of 1.6 μm of the CD-R/RW that is a similar rewritable optical disc, and the influence of crosstalk from the track adjacent to the track which is irradiated with the light beam appears more prominently. The influence of variations in the amplitude and phase of the wobble due to this crosstalk appears not a little as a jitter component in the recording clock which is obtained by performing predetermined multiplication to the frequency of the wobble. Since the recording clock extracted from the wobble is mainly used for recording timing generation such as synchronization of recording data, there is a possibility that a recording position deviation might be caused by the jitter of the recording clock.

Further, the land prepit signal itself has a jitter component due to such as a crosstalk with an already recorded record mark or a difference in the light beam power between the state where the record mark is being formed and the other state.

Accordingly, when performing recording at the recording timing which is determined based on the land pre-pit signal, discontinuity might occur between the previously recorded data and the newly recorded data. Such discontinuity adversely affects the bit synchronization process and the frame synchronization process during reproduction, resulting in a problem that the junction part between the previously recorded data and the newly recorded data cannot be favorably reproduced.

In order to solve this problem, there is proposed a method of reproducing a synchronization signal included in the previously recorded data, and adjusting the timing of data to be newly recorded by using the synchronization signal (for example, refer to Patent Document 1).

However, in the case of reproducing the synchronization signal included in the previously recorded data and adjusting the timing of data to be newly recorded according to the synchronization signal, there is a problem that a deviation in the previously recorded data undesirably remains in the newly recorded data.

In order to solve this problem, there is proposed a method of measuring the position deviation of the recorded data using a detection signal of a land pre-pit being recorded, and varying the frequency of the recording clock according to the deviation amount to correct the deviation (for example, refer to Patent Document 2).

In order to measure the above-mentioned recording deviation amount, it is necessary to detect the land pre-pit signal during recording. Since detection of land pre-pit is performed by binarizing, with a predetermined slice level, the push-pull signal which is obtained when a light beam is applied to the groove track, the signal component of the land pre-pit is undesirably embedded due to a difference in the light beam power between the state where the record mark is being formed during recording and the other state, and thereby the land pre-pit cannot be favorably detected and the recording deviation amount cannot be favorably detected, resulting in a problem that various recording controls cannot be favorably carried out.

In order to solve this problem, there is proposed a method of performing accurate recording control by measuring the recording position deviation amount using a unrecorded area immediately after the end of recording to stably measure the recording deviation amount at the recording end timing even though the land pre-pit signal detection state during recording is bad, and changing the control for next recording with the measured value (for example, refer to Patent Document 3).

Patent Document 1: Japanese Published Patent Application No. 2000-187947

Patent Document 2: Japanese Published Patent Application No. 2003-30841

Patent Document 3: Japanese Published Patent Application No. 2005-310235

### DISCLOSURE OF THE INVENTION

### Problems to be Solved by the Invention

However, the conventional optical disc devices described above have the following drawbacks. Since it is specified in the standard for the DVD-R/RW that the recording deviation amount should be within a predetermined range, it is necessary to confirm whether the recorded disc satisfies this condition or not. Further, also for the DVD+R/RW, it is specified in the standard that the recording deviation amount should be within a predetermined range as in the case of the DVD-R/RW.

However, in the above-described optical disc devices, although the recording deviation amount can be measured during recording or immediately after recording, the recording deviation amounts in the respective regions on the recorded disc cannot be measured. Therefore, it is necessary to confirm the recording deviation amounts in the respective regions by using a measurement device such as an oscilloscope, resulting in considerable man-hours.

The present invention is made to solve the above-described problems and has for its object to provide an optical disc device and a recording deviation amount transfer method, which can judge whether the recording deviation amount of the recorded DVD-R/RW disc or DVD+R/RW disc satisfies the value specified in the standard or not, without requiring considerable man-hours.

### Measures to Solve the Problems

In order to solve the above-described problems, according to Claim 1 of the present invention, there is provided an optical disc device comprising: an address detection circuit which detects a physical address from an optical disc on which physical addresses are previously provided, and outputs a physical address detection signal; a timer which is operated in synchronization with reproduced data from the optical disc; a recording deviation amount measurement circuit which measures a recording deviation amount of data recorded in the optical disc, using the physical address detection signal and the count value of the timer; a data transfer circuit which transfers the recording deviation amount to a memory; and the memory which stores the recording deviation amount transferred from the data transfer circuit.

Therefore, it is possible to confirm whether a recording deviation occurs on the optical disc or not without using such as a measurement device after recording is executed onto the optical disc, and thereby measurement of the recording deviation amount can be executed in a shorter time as compared with the case of measuring a recording deviation on the recorded optical disc using a measurement device such as an oscilloscope.

Further, according to Claim 2 of the present invention, the optical disc device defined in Claim 1 further includes a transfer control system which controls the data transfer timing by the data transfer circuit, and the data transfer circuit transfers information which indicates the detection situation of the physical address and information which indicates the synchronization state with the reproduced data, to the memory at the same timing as the timing for transferring the recording deviation amount.

Therefore, the reliability of the measured recording deviation amount can be judged, and thereby the reliability of the measurement result of the recording deviation amount can be enhanced.

Further, according to Claim 3 of the present invention, the optical disc device defined in Claim 1 further includes a transfer control system which controls the data transfer timing by the data transfer circuit, and the data transfer circuit transfers information which indicates the detection situation of the physical address and information which indicates the synchronization state with the reproduced data, to the memory at a timing different from the timing for transferring the recording deviation amount.

Therefore, as compared with the method of transferring the detection situation of the physical address and the synchronization state with the reproduced data simultaneously with the recording deviation amount, the maximum length of the transferable data length can be used for transferring the recording deviation amount, and thereby measurement of the recording deviation amount can be performed without degrading the measurement precision.

Further, according to Claim 4 of the present invention, the optical disc device defined in Claim 1 or 2 further includes a judgment circuit which compares the recording deviation amount stored in the memory with a predetermined threshold value, judges that a recording deviation of the recorded data occurs when the recording deviation amount stored in the memory is equal to or larger than a predetermined amount, and specifies an address on the optical disc where the recording deviation occurs.

Therefore, when a recording deviation of recorded data occurs on the optical disc, the address where the recording deviation occurs as well as the recording deviation amount can be obtained.

Further, according to Claim 5 of the present invention, the optical disc device defined in Claim 3 further includes a judgment circuit which compares the recording deviation amount stored in the memory with a predetermined threshold value, judges that a recording deviation of the recorded data occurs when the recording deviation amount stored in the memory is equal to or larger than a predetermined amount, and specifies an address on the optical disc where the recording address occurs.

Therefore, when a recording deviation of recorded data occurs on the optical disc, the address where the recording deviation occurs as well as the recording deviation amount can be obtained.

Further, according to Claim 6 of the present invention, the optical disc device defined in Claim 2 further includes a judgment circuit which compares the recording deviation amount stored in the memory with a predetermined threshold value, judges whether the detection situation of the physical address and the synchronization state with the reproduced data satisfy predetermined conditions or not, determines that a recording deviation of the recorded data occurs when the recording deviation amount stored in the memory is equal to or larger than a predetermined amount and the detection situation of the physical address and the synchronization state with the reproduced data satisfy the predetermined conditions, and specifies an address on the optical disc where the recording deviation occurs.

Therefore, when a recording deviation of recorded data occurs on the optical disc, the address where the recording deviation occurs as well as the recording deviation amount can be obtained, and the reliabilities thereof can be enhanced.

Further, according to Claim 7 of the present invention, the optical disc device defined in Claim 3 further includes a judgment circuit which compares the recording deviation amount stored in the memory with a predetermined threshold value, judges whether the detection situation of the physical address and the synchronization state with the reproduced data satisfy predetermined conditions or not, determines that a recording deviation of the recorded data occurs when the recording deviation amount stored in the memory is equal to or larger than a predetermined amount and the detection situation of the physical address and the synchronization state with the reproduced data satisfy the predetermined conditions, and specifies an address on the optical disc where the recording deviation occurs.

Therefore, when a recording deviation of recorded data occurs on the optical disc, the address where the recording deviation occurs as well as the recording deviation amount can be obtained, and the reliabilities thereof can be enhanced.

Further, according to Claim 8 of the present invention, the optical disc device defined in any of Claims 2 to 7 further includes a jitter detection circuit which measures a jitter value of a clock used for detection of the physical address and a jitter value of a clock used for detection of the reproduced data, and the jitter values detected by the jitter detection circuit are transferred to the memory at the same timing as the timing for transferring the recording deviation amount.

Therefore, the reliability of the measured recording deviation amount can be judged, and thereby the reliability of the measurement result of the recording deviation amount can be enhanced.

Further, according to Claim 9 of the present invention, the optical disc device defined in any of Claims 3, 5, and 7 further includes a jitter detection circuit which measures a jitter value of a clock used for detection of the physical address and a jitter value of a clock used for detection of the reproduced data, and the jitter values detected by the jitter detection circuit are transferred to the memory at a timing different from the timing for transferring the recording deviation amount.

Therefore, the reliability of the measured recording deviation amount can be judged, and thereby the reliability of the measurement result of the recording deviation amount can be enhanced.

Further, according to Claim 10 of the present invention, the optical disc device defined in Claim 9 further includes a jitter detection circuit which measures a jitter value of a clock used for detection of the physical address and a jitter value of a clock used for detection of the reproduced data, and the jitter values detected by the jitter detection circuit are transferred to the memory at the same timing as the timing for transferring the information indicating the detection situation of the physical address and the information indicating the synchronization state with the reproduced data.

Therefore, the reliability of the measured recording deviation amount can be judged, and thereby the reliability of the measurement result of the recording deviation amount can be enhanced.

Further, according to Claim 11 of the present invention, in the optical disc device defined in any of Claims 1 to 10, the data transfer circuit is a DMA circuit.

Therefore, data transfer to the memory can be performed with efficiency.

Further, according to Claim 12 of the present invention, in the optical disc device as defined in any of Claims 1 to 11, the optical disc is a DVD-R or a DVD-RW, and the physical address is LPP (Land-Pre-Pit).

Therefore, the deviation amount of the data recorded on the DVD-R or the DVD-RW can be measured in a short time without using a measurement device such as an oscilloscope.

Further, according to Claim 13 of the present invention, in the optical disc device defined in any of Claims 1 to 11, the optical disc is a DVD-R or a DVD-RW, and the physical address is ADIP (Address In Pre-groove).

Therefore, the deviation amount of the data recorded on the DVD-R or the DVD-RW can be measured in a short time without using a measurement device such as an oscilloscope.

Further, according to Claim 14 of the present invention, there is provided a recording deviation amount transfer method comprising: an address detection step of detecting a physical address from an optical disc on which physical addresses are previously provided, and outputting a physical address detection signal; a count value measurement step of measuring a count value which is synchronized with reproduced data from the optical disc; a recording deviation amount measurement step of measuring a recording deviation amount of data recorded on the optical disc by using the physical address detection signal and the count value measured in the count value measurement step; a data transfer step of transferring the recording deviation amount to a memory; and a data storage step of storing the recording deviation amount in the memory.

Therefore, it is possible to confirm whether a recording deviation occurs on the optical disc or not without using such as a measurement device after recording is executed onto the optical disc, and thereby measurement of the recording deviation amount can be executed in a shorter time as compared with the case of measuring a recording deviation on the recorded optical disc using a measurement device such as an oscilloscope.

### Effects of the Invention

According to the optical disc device of the present invention, the recording deviation amount is measured based on the information indicating the detection situation of the physical address and the information indicating the synchronization state with the reproduced data, and the recording deviation amount is transferred to the memory. Therefore, it is possible to confirm as to whether a recording deviation occurs on the optical disc or not without using a measurement device or the like after data are recorded on the optical disc, and thereby measurement of the recording deviation amount can be carried out in a shorter time as compared with the case of measuring a recording deviation on the recorded optical disc by using a measurement device such as an oscilloscope.

Further, when a recording deviation larger than a predetermined amount occurs, the address on the optical disc where the recording deviation occurs is specified. Therefore, when a recording deviation outside the standard occurs, the recording deviation amount and the address where the recording deviation occurs can be displayed and confirmed.

Further, the information indicating the detection situation of the physical address and the information indicating the synchronization state with the reproduced data are transferred to the memory at the same timing as the timing of transferring the recording deviation amount to the memory. Therefore, the reliability of the measured recording deviation amount can be judged, and thereby the reliability of the measurement result of the recording deviation amount can be enhanced.

Furthermore, the information indicating the detection situation of the physical address and the information indicating the synchronization state with the reproduced data are transferred to the memory at a timing different from the timing of transferring the recording deviation amount to the memory. Therefore, as compared with the method of transferring the detection situation of the physical address and the synchronization state with the reproduced data simultaneously with the recording deviation amount, the maximum length of the transferable data length can be used for the transfer of the recording deviation amount, and thereby measurement of the recording deviation amount can be performed without degrading the measurement precision.

### BRIEF DESCRIPTION OF THE DRAWINGS

FIG. 1 is a block diagram illustrating the configuration of an optical disc device according to a first embodiment of the present invention.

FIG. 2 is a timing chart for explaining an operation of transferring a recording deviation amount according to the first embodiment.

FIG. 3 is a block diagram illustrating the configuration of an optical disc device according to a modification of the first embodiment.

FIG. 4 is a timing chart for explaining an operation of transferring a recording deviation amount by the optical disc device of the modification of the first embodiment.

FIG. 5 is a flowchart for confirming whether a recording deviation occurs or not in the optical disc device of the first embodiment.

FIG. 6 is a block diagram illustrating the configuration of an optical disc device according to a second embodiment of the present invention.

FIG. 7 is a timing chart for explaining an operation of transferring a recording deviation amount according to the second embodiment.

FIG. 8 is a block diagram illustrating the configuration of an optical disc device according to a modification of the second embodiment.

FIG. 9 is a timing chart for explaining an operation of transferring a recording deviation amount by the optical disc device of the modification of the second embodiment.

FIG. 10 is a flowchart for confirming whether a recording deviation occurs or not in the optical disc device of the second embodiment.

FIG. 11 is a block diagram illustrating the configuration of an optical disc device according to a third embodiment of the present invention.

FIG. 12 is a timing chart for explaining an operation of transferring a recording deviation amount according to the third embodiment.

FIG. 13 is a block diagram illustrating the configuration of an optical disc device according to a modification of the third embodiment.

FIG. 14 is a timing chart for explaining an operation of transferring a recording deviation amount by the optical disc device of the modification of the third embodiment.

FIG. 15 is a flowchart for confirming whether a recording deviation occurs or not in the optical disc device of the third embodiment.

FIG. 16 is a configuration diagram of an optical disc based on DVD-R/RW standard.

FIG. 17 is a configuration diagram illustrating the structure of land pre-pit information.

FIG. 18 is a timing chart for explaining rewriting of DVD-R/RW.

FIG. 19 is a timing chart for explaining an operation of rewriting when the recording position precision of previously recorded data is low.

### DESCRIPTION OF REFERENCE NUMERALS

1 . . . optical disc

2 . . . spindle motor

3 . . . pickup

4 . . . motor driver

5 . . . power control circuit

6 . . . light beam drive circuit

7 . . . regenerative amplifier

8 . . . pre-pit reproduction circuit

9 . . . wobble reproduction circuit

10 . . . data reproduction circuit

11 . . . reproduction clock generation circuit

12 . . . pre-pit window protection circuit

13 . . . pre-pit sync detection circuit

14 . . . pre-pit demodulation circuit

15 . . . pre-pit address extraction circuit

16 . . . data sync detection circuit

17 . . . data sync window protection circuit

18 . . . 8-16 demodulation circuit

19 . . . data ID extraction circuit

20 . . . recording clock generation circuit

21 . . . lock detection circuit

22 . . . system controller

23 . . . recording control circuit

24 . . . error correction circuit

25 . . . 8-16 modulation circuit

26 . . . recording deviation measurement circuit

27 . . . recording deviation amount transfer control circuit

28 . . . transfer data reception circuit

29 . . . DMA circuit

30 . . . memory

31 . . . transfer data switching circuit

32 . . . data storage buffer

### BEST MODE TO EXECUTE THE INVENTION

### Embodiment 1

Initially, an optical disc based on the DVD-R/RW standard will be described as an example of an optical disc which is recorded and reproduced by an optical disc device of the present invention.

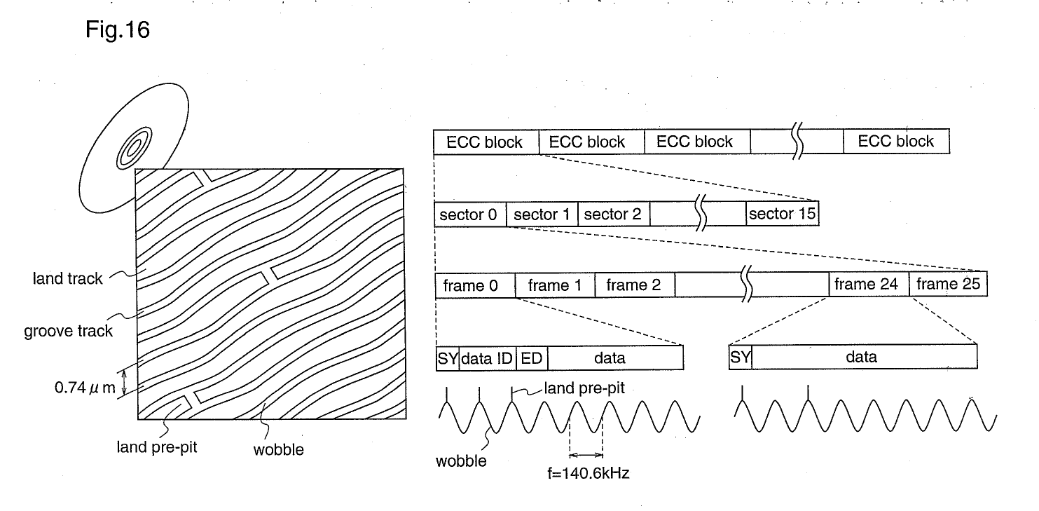

FIG. 16 is a diagram illustrating the configuration of the optical disc based on the DVD-R/RW standard. This optical disc has a spirally formed record groove (groove track), and data recording is performed by irradiating the groove track with a light beam to form record marks in which the optical characteristics of a record film composed of such as an organic dye or a phase-change material are changed.

Data to be recorded is composed of numerous minimum units for error correction which are called ECC (Error Correction Code) blocks. Each ECC block is composed of 16 sectors, and each sector is composed of 26 frames. Each frame is composed of a sync code of 32T and a data code of 1456T (a code of 1488T in total), which codes are obtained by 8-16 modulating a sync signal of 2 bytes and data of 91 bytes. Here, 1T means the unit time length of the record mark, and it corresponds to 38.2 ns (1/(26.16 MHz)) at the standard speed of the DVD-R/RW. The sync code is composed of a code including “a 14T wide record mark and a 4T wide space (an area sandwiched by a record mark and a record mark)” or “a 14T wide space and a 4T wide record mark”. An address information of 4 bytes which is called data ID and an ID error detection code of 2 bytes which is called IED (ID Error Detection code) are included in the head frame of each sector.

The groove track has waves (wobbles) of a predetermined frequency. The frequency of the wobbles is about 140.6 KHz at the standard speed, and a clock signal of the unit time length of the record mark can be obtained by 186-multiplying the frequency of the wobbles (140.6 KHz×186=26.16 MHz). That is, one wobble corresponds to a period of 186T, and eight wobbles are included in one frame (1488T).

Further, on the optical disc, pits having a convex shape viewed from the light beam radiation surface, which are called land pre-pits (LPP), are previously embedded in the land track between the groove tracks during the manufacturing process, as recording position references and physical address information. The land pre-pits are corresponded to the groove tracks on the inner circumference side, and are positioned at the peaks of the wobbles of the groove tracks on the inner circumference side.

Among the 26 frames constituting each sector, the even-numbered frames are called “EVEN frames” while the odd-numbered frames are called “ODD frames”, and particularly, the 0th frame is called “EVEN sync frame” and the 1st frame is called “ODD sync frame”. While the LPP codes which are subjected to the conversion shown in the following Table 1 are fundamentally arranged at the peak positions of the top three wobbles among the eight wobbles in the EVEN frame, if the LPP codes on the inner circumference side and the outer circumference side viewed from the groove track are overlapped each other, the LPP code on the outer circumference side is arranged shifted to the ODD frame to avoid crosstalk between the LPP codes.

By inversely converting the land pre-pits for one sector using the following Table 1, sync code of 1 bit+LPP information of 12 bits can be obtained.

TABLE 1

| bit 2 | bit 1 | bit 0 | meaning |
|---|---|---|---|
| 1 | 1 | 1 | EVEN sync |
| 1 | 1 | 0 | ODD sync |
| 1 | 0 | 1 | data “1” |
| 1 | 0 | 0 | data “0” |

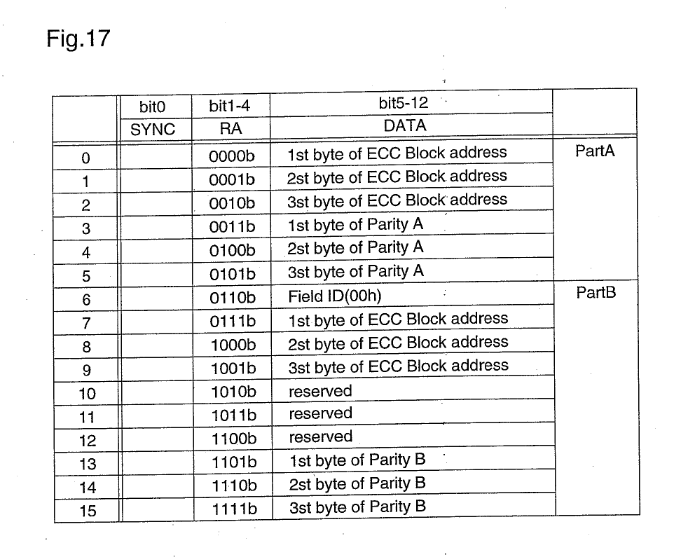

FIG. 17 shows the structure of the LPP information. The LPP information is integrated in ECC block units (16 sectors). The top 4 bits in the 12-bit LPP information obtained for each sector are called RA (Relative Address), which shows the sector number in the ECC block. The remaining 8 bits are data, and the data are composed of two pairs of ECC block address (hereinafter referred to as pre-pit address) and error correction code (parity) for each ECC block.

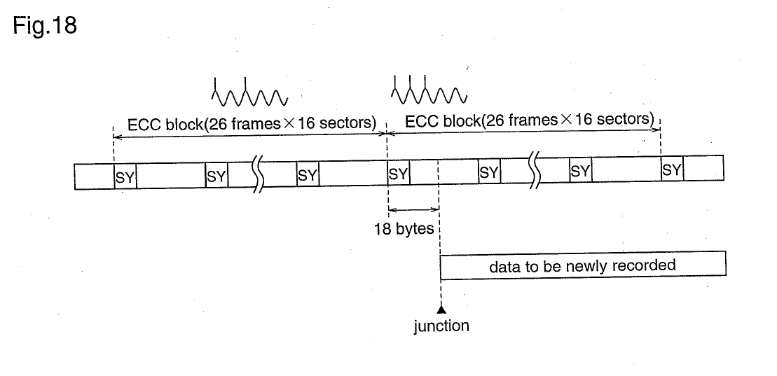

FIG. 18 shows the timing diagram of rewriting of the DVD-R/RW. When recording data on the optical disc, data are recorded in the circumferential position where the land pre-pit at the heads of each frame overlaps the 14T included in the sync codes of the recorded data. The recording is performed with the ECC block as a minimum unit, and the start and end of the recording are positioned at the 18th byte in the head frame in the head sector of the ECC block.

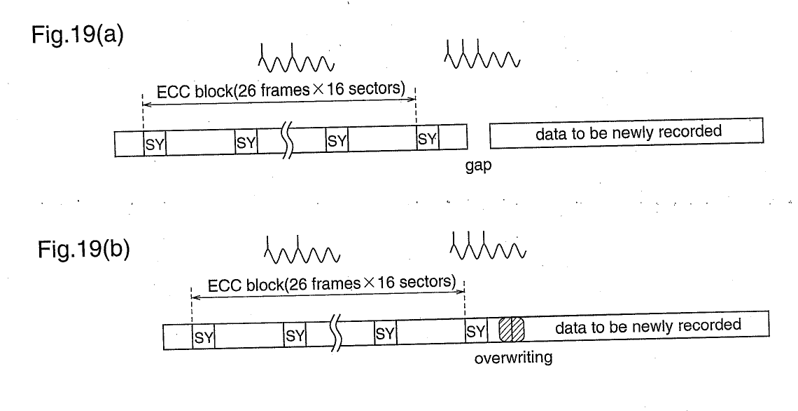

It is called “linking” to record new data so as to be combined with the already recorded data, and a very high recording position precision is required so as to avoid data discontinuity due to such as overwriting of new data on the already recorded data, or a gap between the already recorded data and the newly recorded data as shown in FIG. 19.

Hereinafter, the optical disc device of the first embodiment will be described with reference to the drawings.

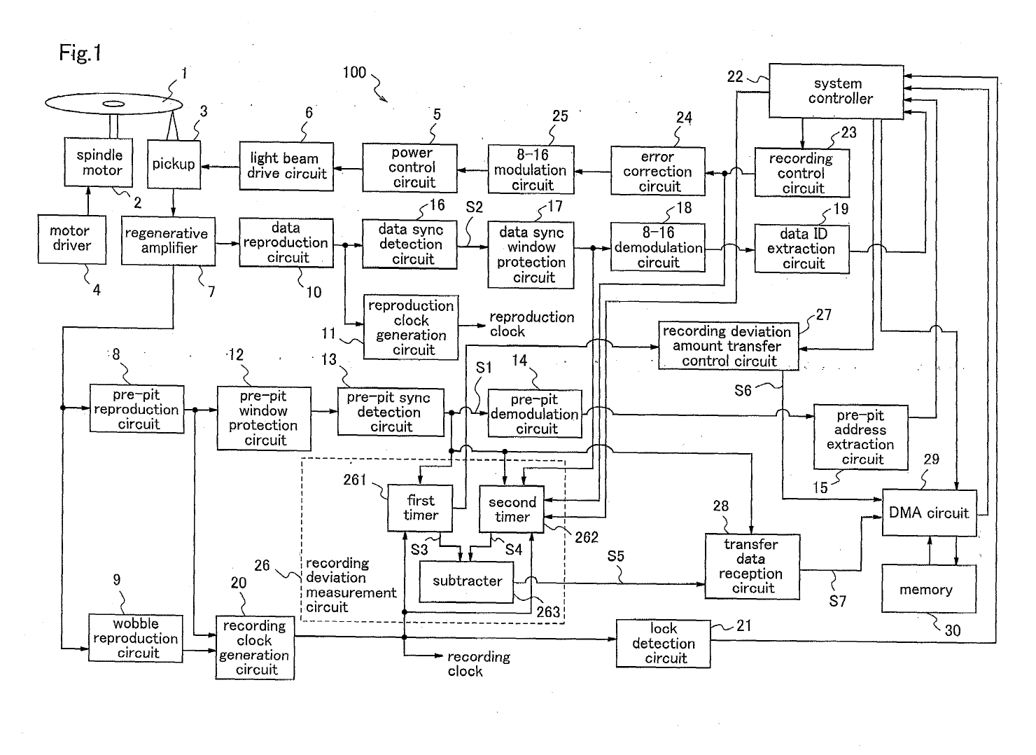

FIG. 1 is a block diagram illustrating the optical disc device of the first embodiment.

With reference to FIG. 1, the optical disc device 100 of this first embodiment comprises an optical disc 1, a spindle motor 2, a pickup 3, a motor driver 4, a power control circuit 5, a light beam drive circuit 6, a regenerative amplification circuit 7, a pre-pit reproduction circuit 8, a wobble reproduction circuit 9, a data reproduction circuit 10, a reproduction clock generation circuit 11, a pre-pit window protection circuit 12, a pre-pit sync detection circuit 13, a pre-pit demodulation circuit 14, a pre-pit address extraction circuit 15, a data sync detection circuit 16, a data sync window protection circuit 17, a 8-16 demodulation circuit 18, a data ID extraction circuit 19, a recording clock generation circuit 20, a lock detection circuit 21, a system controller 22, a recording control circuit 23, an error correction circuit 24, a 8-16 modulation circuit 25, a recording deviation measurement circuit 26, a recording deviation amount transfer control circuit 27, a transfer data reception circuit 28, a DMA circuit 29, and a memory 30.

The spindle motor 2 is driven by the motor driver 4, and rotates the optical disc 1 with a predetermined rotation frequency. The pickup 3 radiates a light beam having a predetermined reproduction power. The light beam emitted from the pickup 3 is driven by a drive signal which is converted by the light beam driving circuit 6. The light beam driving circuit 6 is controlled based on a reproduction power control signal outputted from the power control circuit 5. The light beam applied to the optical disc 1 becomes a reflection light according to the optical characteristics and physical characteristics of the recording film of the optical disc 1 to be again applied to the pickup 3. The pickup 3 has plural light-receiving circuits (not shown), and the light-receiving circuits convert the light amount of the incident reflection light into electric signals, respectively.

The regenerative amplification circuit 7 adds all the electric signals obtained by the respective light-receiving circuits to obtain a more amplified RF (Radio Frequency) signal, and obtains differences between the respective electric signals obtained by the light-receiving circuits which are separated in approximately parallel to the track, thereby generating a more amplified push-pull signal.

The pre-pit reproduction circuit 8 has a comparator (not shown) which performs comparison of the signal level of the push-pull signal with a slice level of an approximately intermediate value between the maximum level of the land pre-pit part and the maximum level of the fluctuation part due to wobble, and outputs a pulse pre-pit signal which is H level when the signal level is larger than the slice level, and L level when the signal level is smaller than the slice level.

The wobble reproduction circuit 9 includes a BPF (Band Pass Filter) which passes a frequency component of wobble (about 140.6 KHz at the standard speed), and a comparator (not shown) which compares the level of the signal that has passed through the BPF with the slice level of an approximately intermediate value of the amplitude of the wobble part, and the wobble reproduction circuit 9 outputs a rectangle-wave wobble signal which is H level when the signal level obtained after the noise component and the land pre-pit component are removed through the BPF is larger than the slice level, and L level when the signal level is smaller than the slice level.

The data reproduction circuit 10 includes a comparator (not shown) which compares the level of the RF signal with a slice level at which the integrated value of the H level of the RF signal and the integrated value of the L level of the RF signal within a predetermined section are approximately equal to each other, and outputs a data reproduction signal which is H level when the signal level is larger than the slice level, and L level when the signal level is smaller than the slice level.

The reproduction clock generation circuit 11 performs frequency control such that 3 waves of reproduction clocks are included in the shortest width (3T) of the H level or L level of the data reproduction signal and 14 waves of reproduction clocks are included in the longest width (14T) of the H level or L level of the data reproduction signal, thereby generating a reproduction clock having a frequency of 1T.

The pre-pit window protection circuit 12 predicts the appearance position of the next pre-pit signal on the basis of the previously detected pre-pit signal, excludes the pre-pit signals which are detected at the positions other than the predicted appearance position, thereby to reduce false detection of the land pre-pits. The pre-pit sync detection circuit 13 extracts a pre-pit sync signal S1 corresponding to the head land pre-pit in the LPP code from the window-protected pre-pit signal.

The pre-pit demodulation circuit 14 converts the pre-pit signal according to Table 1 in synchronization with the pre-pit sync signal S1, thereby obtaining pre-pit information. The pre-pit address extraction circuit 15 obtains the RA and the LPP information in synchronization with the EVEN sync or the ODD sync in the pre-pit information, stores the LPP information in the memory based on the RA, performs predetermined error correction, and extracts the pre-pit address.

The data sync detection circuit 16 synchronizes the data reproduction signal at the timing of the reproduction clock, and detects the sync code including 14T4T to output a data sync detection signal S2. The data sync window protection circuit 17 predicts the appearance position of the next data sync detection signal S2 on the basis of the previously detected data sync detection signal S2, and excludes the data sync detection signals S2 detected at the positions other than the predicted appearance position, thereby to reduce false detection of the data sync.

The 8-16 demodulation circuit 18 performs 8-16 demodulation with reference to the window-protected data sync detection signal S2 to output demodulated data. The data ID extraction circuit 19 extracts data ID from the demodulated data.

The recording clock generation circuit 20 outputs a recording clock which is frequency-controlled by the wobble signal and the pre-pit signal. The lock detection circuit 21 detects that the recording clock is within a predetermined frequency range and is stable, and outputs a lock signal.

The recording deviation measurement circuit 26 detects a recording deviation amount from the pre-pit signal and the count value of the timer which is synchronized with the recorded data. The recording deviation measurement circuit 26 comprises a first timer 261, a second timer 262, and a subtracter 263.

The first timer 261 is configured by a counter (not shown) which is preset to a predetermined value by the pre-pit sync signal S1, and counts the number of the recording clocks. When no pre-pit sync signal S1 is inputted, it is reset to 0 for each frame (1488 counts). This first timer 261 is preset regardless of recording or non-recording. That is, it serves as a timer which operates in synchronization with the land pre-pit.

The second timer 262 is configured by a counter (not shown) which selects either of the pre-pit sync signal S1 or the data sync detection signal S2, is preset to a predetermined value when the selected signal is inputted, and counts the number of the recording clocks. When the selected signal is not inputted, it is reset to 0 for each frame (1488 counts). This second timer 262 can selects the preset period between the non-recording period and the period before recording. In this first embodiment, the second timer 262 is set so as to be preset during non-recording by the data sync detection signal S1. The timer value of this second timer 262 is also used as a recording data generation timing. That is, it serves as a timer which operates in synchronization with the recording data.

The preset values of the first timer 261 and the second timer 262 are such values that, when the land pre-pit and 14T of the data sync of the recording data are recorded overlapped with each other, a difference between the respective timer values becomes “0”.

The subtracter 263 is operated only when recording is performed, or when the device is in a predetermined state after recording is completed, or when measurement of the recording deviation amount is instructed, and it outputs a difference between the value S3 of the first timer 261 and the value S4 of the second timer 262 as a recording position deviation amount S5. In this first embodiment, since the count value of each timer is provided only for one frame (1488 counts), a deviation of ±½ frame at maximum can be measured. Since a value exceeding ±½ frame might be outputted depending on the value of the first timer 261 and the value of the second timer 262, it is necessary to fold back the measured value so as to fall within the range of ±½ frame by adding or subtracting one frame to/from the measured value. When the count values of the first timer 261 and the second timer 262 are increased, larger recording deviation can be measured.

When the system controller 22 is instructed by a control unit (not shown) to measure the recording deviation amount, the system controller 22 sets the preset signal of the second timer 262 to the data sync detection signal S2, and sets the preset period of the second timer 262 in the non-recording period. Further, when the system controller 22 detects the lock signal indicating that the data reading position reaches the address where the recording deviation amount is to be measured and the recording clock is stabilized, with reference to the extracted pre-pit address or data ID, the system controller 22 instructs the recording deviation amount transfer control circuit 27 to transfer the recording deviation amount. Further, the system controller 22 compares the recording deviation amount detected from the optical disc 1 with the threshold value which is set by the control unit (not shown) to judge whether the recording deviation amount is larger than the predetermined amount or not.

The recording control circuit 23 determines the recording start point on the basis of the recording instruction from the system controller 22, and generates a recording gate signal. To be specific, when no data is recorded immediately before the recording start point, the recording control circuit 23 determines the recording start point by the pre-pit signal to generate the recording gate signal. When data is recorded immediately before the recording start point, the recording control circuit 23 determines the recording start point by the data sync detection signal S2 to generate the recording gate signal. The error correction circuit 24 adds an error correction code to the recorded data when the recording gate signal is outputted from the recording control circuit 23. The 8-16 modulation circuit 25 performs 8-16 modulation to the signal outputted from the error correction circuit 24, and outputs this modulated signal in synchronization with the recording clock.

The recording deviation amount transfer control circuit 27 decodes the value of the first timer 261 on the basis of the recording deviation amount transfer instruction from the system controller 22, and when the value of the first timer 261 is sufficiently apart from the value at which the first timer 261 is preset by the pre-pint sync signal S1, the recording deviation amount transfer control circuit 27 generates a recording deviation amount transfer timing signal S6 indicating the timing of data transfer by the DMA circuit 29, and outputs the same to the DMA circuit 29.

The transfer data reception circuit 28 receives the recording deviation amount S5 outputted from the subtracter 263 at the timing one cycle after outputting of the pre-pit sync signal S1, and outputs the same to the DMA circuit 29 as transfer data S7.

On receipt of the recording deviation amount transfer timing signal S6, the DMA circuit 29 stores the transfer data S7 outputted from the transfer data reception circuit 28 in the memory 30.

Next, the operation of the optical disc device 100 configured as described above will be described.

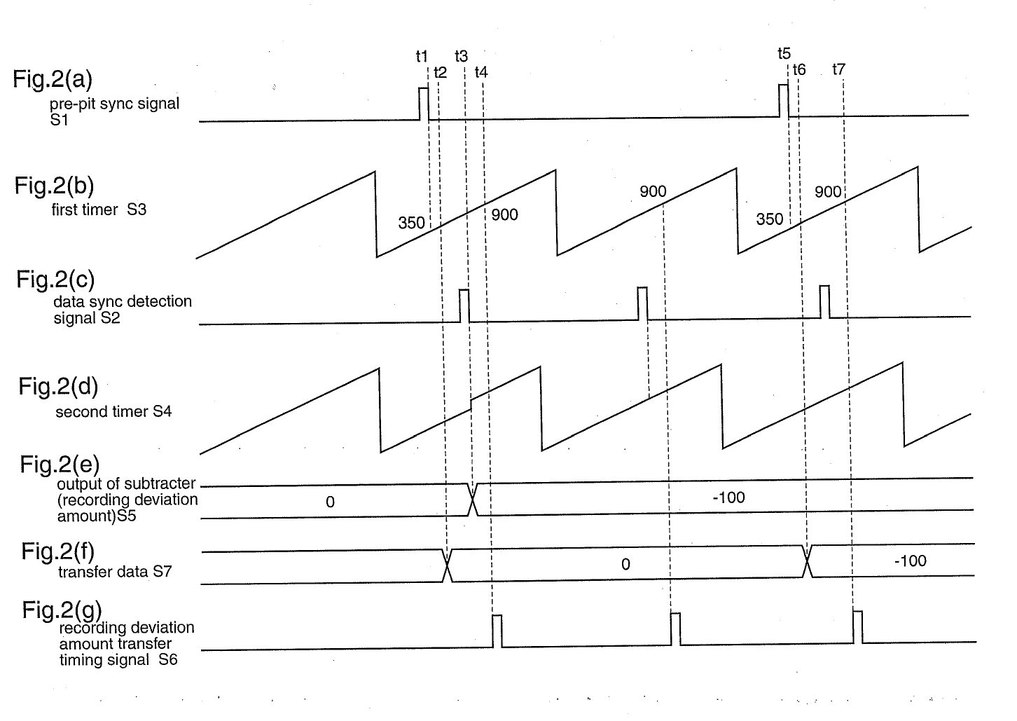

Initially, the recording deviation amount transfer operation will be described with reference to the timing chart shown in FIG. 2.

In FIG. 2, (a) shows the pre-pit sync signal S1, (b) shows the output S3 from the first timer 261, (c) shows the data sync detection signal S2, (d) shows the output S4 from the second timer 262, (e) shows the output S5 from the subtracter 263, (f) shows the transfer data S7 outputted from the transfer data reception circuit 28, and (g) shows the recording deviation amount transfer timing signal S6.

Initially, when the pre-pit sync signal is input to the first timer 261, the first timer 261 is preset to a predetermined preset value at timing t1. The outputs from the first timer 261 and the second timer 262 are input to the subtracter 263. The subtracter 263 performs subtraction between the value S3 of the first timer 261 and the value S4 of the second timer 262, and outputs the recording deviation amount S5 “0” to the transfer data reception circuit 28.

The recording deviation amount S5 outputted from the subtracter 263 is received by the transfer data reception circuit 28 at timing t2 which is one cycle after outputting of the pre-pit sync signal S1, and outputted to the DMA circuit 29 as the transfer data S7.

Next, when the data sync detection signal S2 is input to the second timer 262, the second timer 262 is preset to a predetermined preset value at timing t3, and the recording deviation amount S5 outputted from the subtracter 263 becomes “−100” as shown in FIG. 2.

Next, at timing t4 when the value of the first timer 261 becomes the predetermined value, a recording deviation amount transfer timing signal S6 is generated by the recording deviation amount transfer control circuit 29, and outputted to the DMA circuit 29. As the result, a write enable is outputted from the DMA circuit 29, and thereby the transfer data S7 “0” outputted from the transfer data reception circuit 28 is written in the memory 30. Thereafter, the write address of the memory 30 is advanced by one.

Thereafter, the pre-pit sync signal S1 is outputted at timing t5. Then, at timing t6 which is one cycle after timing t5, the recording deviation amount S5 “−100” outputted from the subtracter 263 is received by the transfer data reception circuit 28, and outputted to the DMA circuit 29 as the transfer data S7. Then, at timing t7 when the value of the first timer 261 becomes the predetermined value, a recording deviation amount transfer timing signal S6 is generated, and thereby the transfer data S7 “−100” is written in the memory 30 by the DMA circuit 29.

Thereafter, the above-described operation is carried out and the recording deviation amount S5 is stored in the memory 30, until the system controller 22 receives the recording deviation amount transfer end instruction.

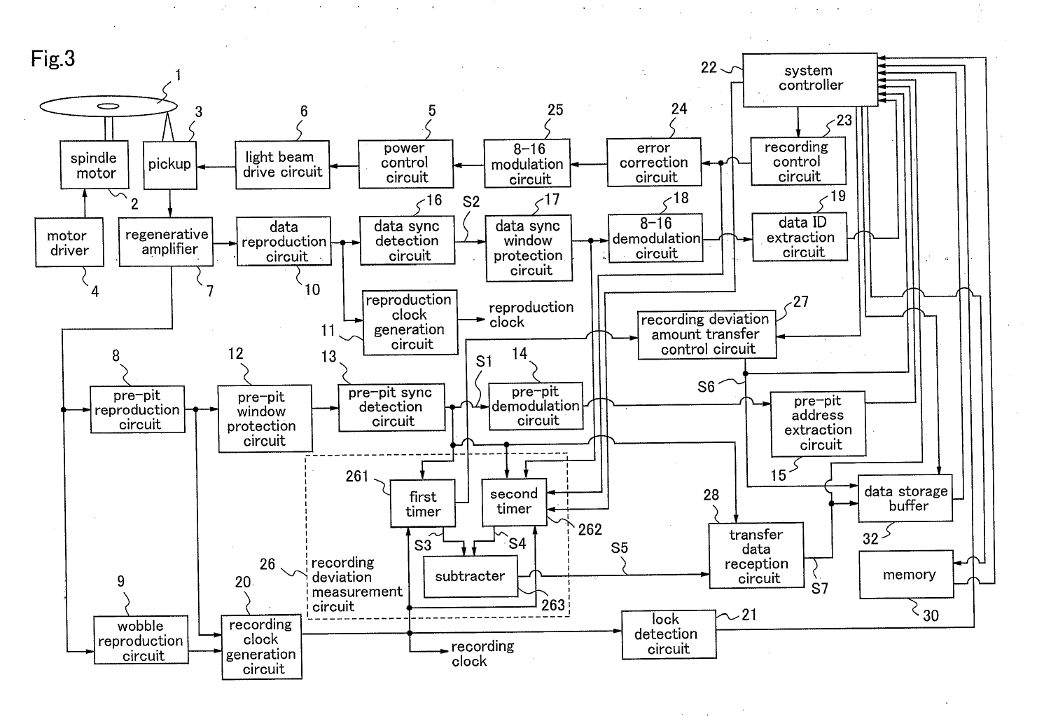

While data transfer is performed by the DMA circuit 29 in the above-described optical disc device 100, it is possible to perform data transfer without using the DMA circuit 29 by that, as shown in FIG. 3, the recording deviation amount transfer timing signal S6 is input to the system controller 22 as an interruption signal, and when the interruption signal is inputted, the system controller 22 receives the transfer data S7 from the transfer data reception circuit 28 and transfers the same to a predetermined address in the memory 30. The interruption signal which activates data transfer may be a signal other than the recording deviation amount transfer timing signal S6.

Further, when the output interval of the interruption signal is longer than the output interval of the recording deviation amount transfer timing signal S6, or when the number of interruptions is reduced to prevent the processing of the system controller 22 from being compressed due to frequent interruptions, or when data transfer after inputting of the interruption signal cannot be completed by the time the next recording deviation amount is obtained, it is possible to prevent the transfer data amount from being reduced by providing a data storage buffer 32 as shown in FIG. 3 to store the recording deviation amount in the data storage buffer 32.

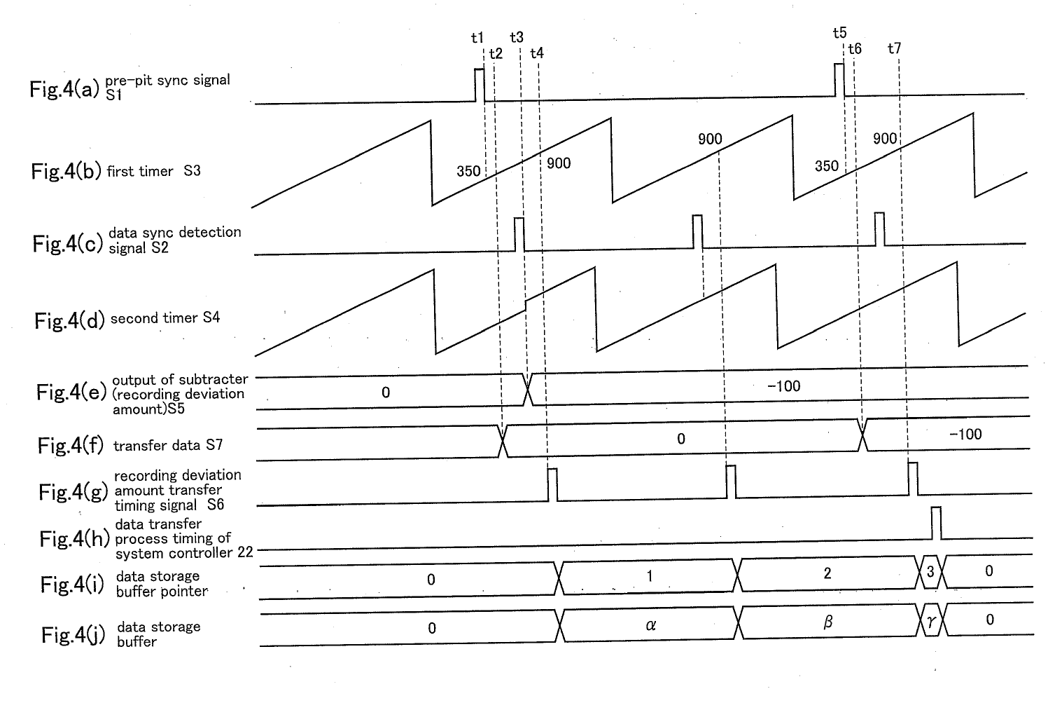

FIG. 4 is a diagram illustrating the operation timing when performing data transfer using the data storage buffer 32, and it shows the operation timing in the case where the system controller 22 transfers the transfer data S7 every time it receives the recording deviation amount transfer timing signals S6 three times.

In FIG. 4, (h) shows the data transfer processing timing signal by the system controller 22. (i) shows the contents of a storage buffer pointer possessed by the data storage buffer 32. The data storage pointer controls the data storage position, and shows the data amount to be transferred when the system controller 22 transfers the data, and it is initialized when the data is transferred from the data storage buffer 32. (j) shows the contents of the data storage buffer 32, wherein α shows the state of holding the transfer data 0, β shows the state of holding the transfer data 0,0, and γ shows the state of holding the transfer data 0,0,−100.

As shown in FIG. 4, the value of the storage buffer pointer and the contents of the data in the storage buffer are updated every time the recording deviation amount transfer timing signal S6 is outputted. When the recording deviation amount transfer timing signal S6 has been outputted three times, the system controller 22 receives the transfer data γ from the data storage buffer 32, and transfers the same to the predetermined address in the memory 30.

Thereby, it is possible to prevent reduction in the transfer data amount even when the number of data transfers is reduced with respect to the number of interruptions.

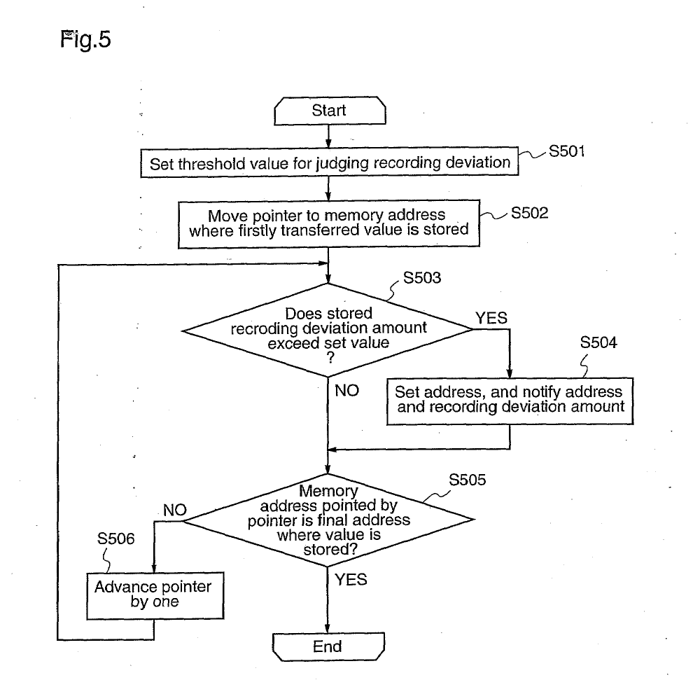

Next, the operation of judging whether a recording deviation outside the standard occurs or not will be described with reference to a flowchart shown in FIG. 5.

Initially, the control unit (not shown) which instructs the recording deviation amount confirming operation sets a threshold value of a recording deviation amount for judging that recording deviation occurs on the system controller 22 (step S501).

Next, the system controller 22 moves the pointer to the memory address where the recording deviation amount S5 is firstly stored (step S502), and judges whether the recording deviation amount S5 stored in the memory address exceeds the set threshold value or not (step S503). When the recording deviation amount S5 exceeds the threshold value, the system controller 22 specifies the address on the optical disc 1 where the recording deviation occurs, on the basis of the value of the pointer and the address on the optical disc 1 from which transfer of the recording deviation amount S5 has been started, and notifies the control unit of the address and the recording deviation amount S5 (step S504).

When the notification of the address where the recording deviation occurs and the recording deviation amount S5 (step S504) is completed or when the judgment result in step S503 is “NO”, the process goes to step S505 to judge whether or not the memory address pointed by the pointer is the final address where the value of the recording deviation amount S5 is stored (step S505). When the memory address pointed by the pointer is not the final address, the pointer is advanced by one (step S506), and the process returns to step S503 for judging whether the stored recording deviation amount S5 exceeds the set threshold value or not. When the memory address pointed by the pointer is the final address, the recording deviation confirming operation is ended. Further, it is possible to confirm the position on the optical disc where the recording deviation occurs and the recording deviation amount S5 by displaying the address and the recording deviation amount S5 which are notified to the control unit in step S504 on a display unit (not shown) of the optical disc device.

As described above, according to the optical disc device of this first embodiment, the recording deviation amount of the recorded data is calculated based on the output of the first timer which is operated in synchronization with the pre-pit sync signal and the output of the second timer which is operated in synchronization with the data sync detection signal, and the calculated recording deviation amount is transferred to the memory. Therefore, the recording deviation which occurs on the optical disc can be directly confirmed without using a measurement device or the like, and thereby it is possible to significantly reduce the man-hours which have conventionally been required for measurement of the recording deviation amount on the disc using an oscilloscope or the like.

Further, it is judged whether a recording deviation exceeding a predetermined amount occurs or not, and when such recording deviation occurs, the address on the optical disc where such recording deviation occurs and the recording deviation amount are displayed. Therefore, it is possible to confirm whether a recording deviation specified in the standard occurs or not, as well as its occurrence position.

In the optical disc device 100 of this first embodiment, the jitter values of the reproduction clock and the recording clock may be measured by using circuits for measuring the jitters of the respective clocks which are provided in the stages subsequent to the reproduction clock generation circuit 11 and the recording clock generation circuit 20, respectively, and the measured jitter values may be input to the transfer data reception circuit 28. Thereby, the measured jitter values can be transferred to the memory 30 together with the recording deviation amount S5, and the reliability of the measurement result of the recording deviation amount can be further enhanced.

### Embodiment 2

Next, an optical disc device according to a second embodiment of the present invention will be described with reference to the drawings.

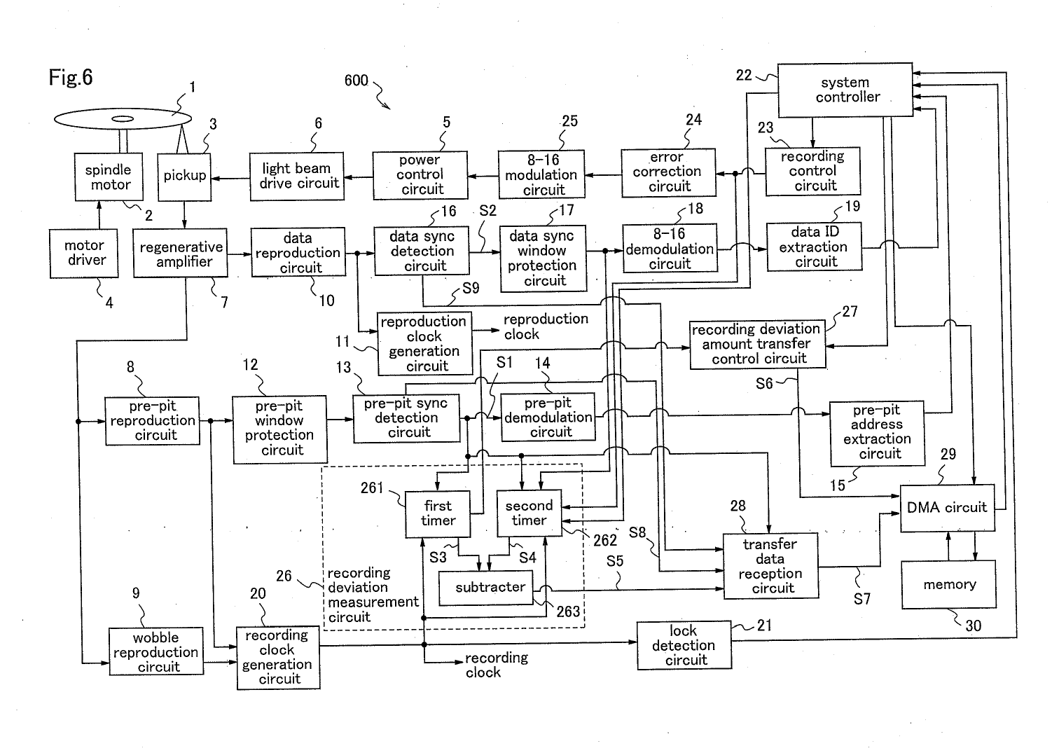

FIG. 6 is a block diagram illustrating the optical disc device of the second embodiment.

As shown in FIG. 6, the optical disc device 600 of this second embodiment comprises an optical disc 1, a spindle motor 2, a pickup 3, a motor driver 4, a power control circuit 5, a light beam drive circuit 6, a regenerative amplification circuit 7, a pre-pit reproduction circuit 8, a wobble reproduction circuit 9, a data reproduction circuit 10, a reproduction clock generation circuit 11, a pre-pit window protection circuit 12, a pre-pit sync detection circuit 13, a pre-pit demodulation circuit 14, a pre-pit address extraction circuit 15, a data sync detection circuit 16, a data sync window protection circuit 17, a 8-16 demodulation circuit 18, a data ID extraction circuit 19, a recording clock generation circuit 20, a lock detection circuit 21, a system controller 22, a recording control circuit 23, an error correction circuit 24, a 8-16 modulation circuit 25, a recording deviation measurement circuit 26, a recording deviation amount transfer control circuit 27, a transfer data reception circuit 28, a DMA circuit 29, and a memory 30.

In the optical disc device 600 of this second embodiment, the pre-pit sync detection circuit 13 generates a pre-pit detection situation S8 showing the detection situation of the pre-pit sync signal S1, and outputs the same to the transfer data reception circuit 28. The data sync detection circuit 16 generates a data sync detection situation S9 indicating the detection situation of the data sync detection signal S2, and outputs the same to the transfer data reception circuit 28.

The transfer data reception circuit 28 outputs the pre-pit detection situation S8 and the data sync detection situation S9 as well as the recording deviation amount S5 outputted from the subtracter 263, as the transfer data S7 to the DMA circuit 29.

In FIG. 6, since the other constituents are identical to those of the first embodiment, repeated description is not necessary.

Next, the operation of the optical disc device 600 configured as described above will be described.

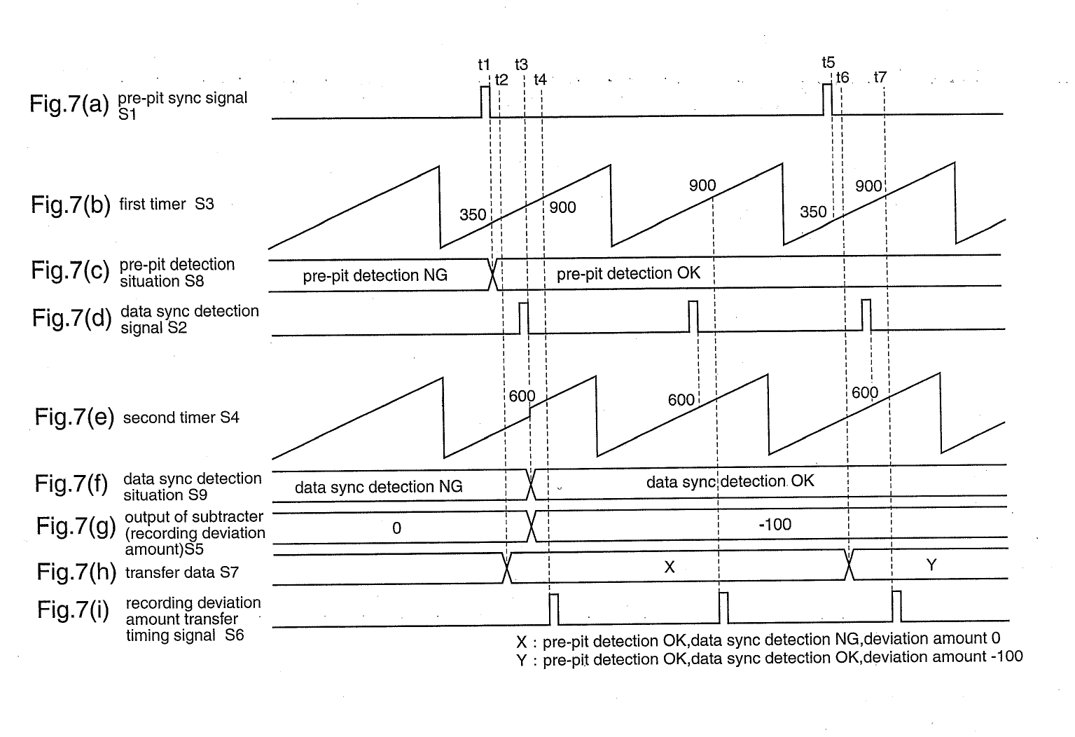

Initially, the recording deviation amount transfer operation will be described with reference to the timing chart shown in FIG. 7.

In FIG. 7, (a) shows the pre-pit sync signal S1, (b) shows the output S3 from the first timer 261, (c) shows the pre-pit detection situation S8, (d) shows the data sync detection signal S2, (e) shows the output S4 from the second timer 262, (f) shows the data sync detection situation S9, (g) shows the output S5 from the subtracter 263, (h) shows the transfer data S7, and (i) shows the recording deviation amount transfer timing signal S6.

Initially, when the pre-pit sync signal S1 is input to the first timer 261, the first timer 261 is preset to a predetermined preset value at timing t1. The outputs from the first timer 261 and the second timer 262 are input to the subtracter 263, and the subtracter 263 performs subtraction between the value S3 of the first timer 261 and the value S4 of the second timer 262, and outputs the recording deviation amount S5 “0” to the transfer data reception circuit 28. Further, the pre-pit detection situation S8 indicating that the pre-pit sync signal S1 is detected is outputted from the pre-pint sync detection circuit 13 to the transfer data reception circuit 28, and the data sync detection situation S9 indicating that the data sync detection signal S2 is not yet detected is outputted from the data sync detection circuit 16 to the transfer data reception circuit 28.

The recording deviation amount S5, the pre-pit detection situation S8, and the data sync detection situation S9 are received by the transfer data reception circuit 28 to be outputted to the DMA circuit 29 as the transfer S7 shown by “X” in the figure, at timing t2 which is one cycle after the outputting of the pre-pit sync signal S1.

Next, when the data sync detection signal S2 is input to the second timer 262, the second timer 262 is preset to a predetermined preset value at timing t3, and the recording deviation amount S5 outputted from the subtracter 263 becomes “−100” as shown in FIG. 7. Further, the data sync detection situation S9 outputted from the data sync detection circuit 16 indicates that the data sync detection signal S2 is detected.

When a recording deviation amount transfer timing signal S6 is generated by the recording deviation amount transfer control circuit 29 and outputted to the DMA circuit 29 at timing t4, the DMA circuit 29 outputs a write enable, and thereby the transfer data S7 “X” outputted from the transfer data reception circuit 28 is written in the memory 30. Thereafter, the write address of the memory 30 is advanced by one. In this way, the recording deviation amount S5 is transferred to the memory 30 together with the detection situation of the pre-pit sync signal S1 and the detection situation of the data sync detection signal S2.

Thereafter, the pre-pit sync signal S1 is outputted at timing t5. Then, at timing t6 which is one cycle after timing t5, the recording deviation amount S5 “−100” outputted from the subtracter 263, the pre-pit detection situation S8 outputted from the pre-pit sync detection circuit 13, and the data sync detection situation S9 outputted from the data sync detection circuit 16 are received by the transfer data reception circuit 28 to be outputted to the DMA circuit 29 as the transfer data S7 which is shown by “Y” in the figure. Then, at timing t7 when the value of the first timer 261 becomes the predetermined value, the transfer data S7 “Y” is written in the memory 30 by the DMA circuit 29.

Thereafter, the above-described operation is carried out and the recording deviation amount S5 is stored in the memory 30 until the system controller 22 receives the recording deviation amount transfer end instruction.

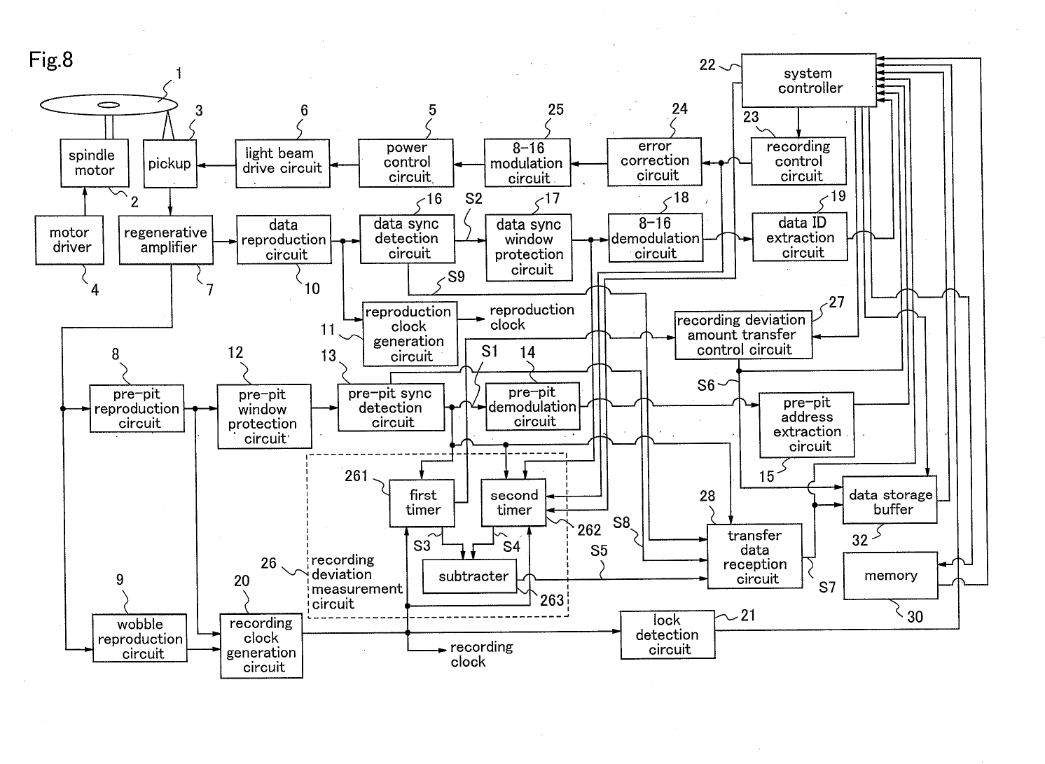

While in the above-described optical disc device 600 data transfer is performed by the DMA circuit 29, data transfer can be performed without using the DMA circuit 29 by that, as shown in FIG. 8, the recording deviation amount transfer timing signal S6 is input to the system controller 22 as an interruption signal, and when the interruption signal is inputted, the system controller 22 receives the transfer data S7 from the transfer data reception circuit 28 and transfers the same to a predetermined address in the memory 30. The interruption signal which activates the data transfer may be a signal other than the recording deviation amount transfer timing signal S6.

Further, when the output interval of the interruption signal is longer than the output interval of the recording deviation amount transfer timing signal S6, or when the number of interruptions is reduced to prevent the processing of the system controller 22 from being compressed due to frequent interruptions, or when the data transfer process after inputting of the interruption signal cannot be completed by the time the next recording deviation amount is obtained, it is possible to prevent the transfer data amount from being reduced by providing a data storage buffer 32 as shown in FIG. 8 to store the recording deviation amount in the data storage buffer 32.

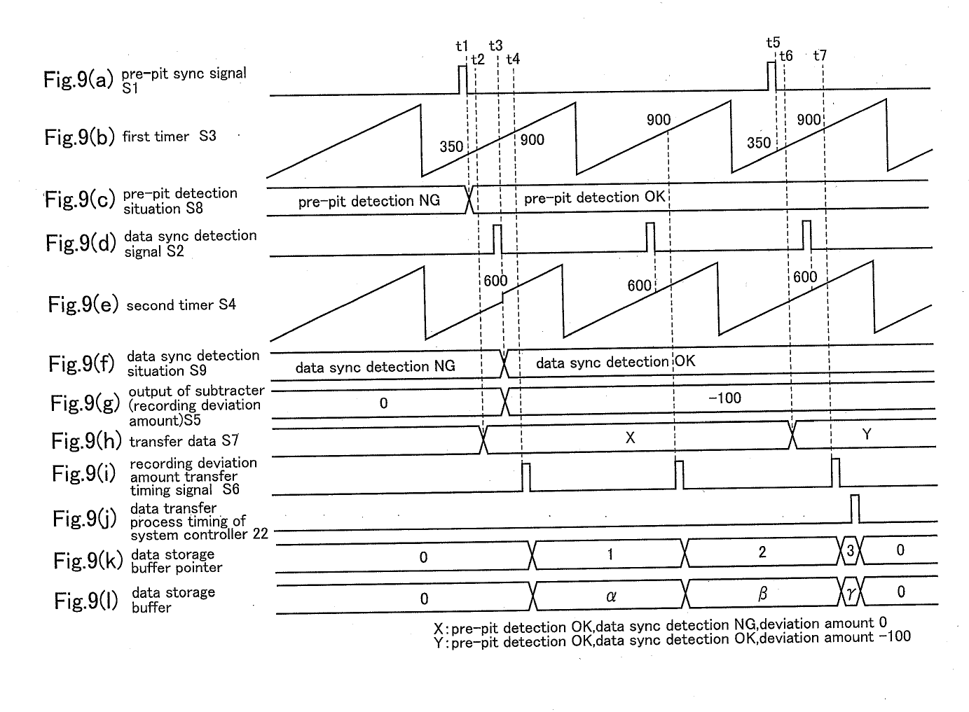

FIG. 9 is a diagram illustrating the operation timing when performing data transfer using the data storage buffer 32, and shows the operation timing in the case where the system controller 22 transfers the transfer data S7 every time it receives the recording deviation amount transfer timing signals S6 three times.

In FIG. 9, (j) shows the data transfer process timing signal by the system controller 22. (k) shows the contents of a storage buffer pointer possessed by the data storage buffer 32. The data storage pointer controls the data storage position, shows the data amount required to be transferred when the system controller 22 transfers the data, and is initialized when the data is transferred from the data storage buffer 32. (l) shows the contents of the data storage buffer 32, wherein α shows the state of holding the transfer data X, β shows the state of holding the transfer data X,X, and γ show the state of holding the transfer data X,X,Y.

As shown in FIG. 9, the value of the data storage buffer pointer and the contents of the data in the data storage buffer 32 are updated every time the recording deviation amount transfer timing signal S6 is outputted. When the recording deviation amount transfer timing signal S6 has been outputted three times, the system controller 22 receives the transfer data γ from the data storage buffer 32, and transfers the same to the predetermined address in the memory 30.

Thereby, it is possible to prevent the transfer data amount from being reduced even when the number of data transfers is reduced with respect to the number of interruptions.

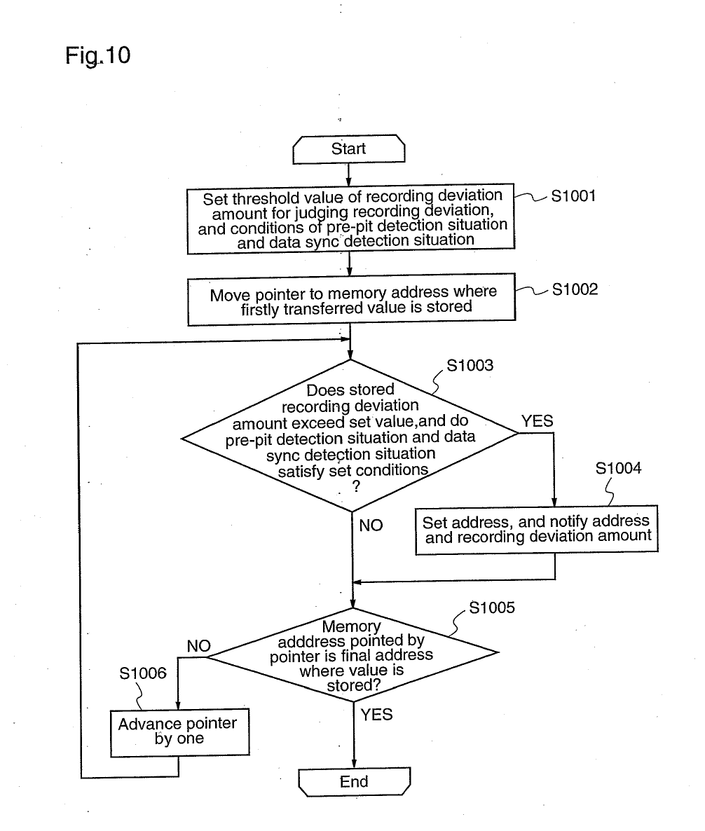

Next, the operation of judging whether a recording deviation outside the standard occurs or not will be described with reference to a flowchart shown in FIG. 10.

Initially, the control unit (not shown) which instructs the recording deviation amount confirming operation sets, on the system controller 22, the threshold value of the recording deviation amount for judging that a recording deviation occurs, and the conditions of the pre-pit detection situation and the data sync detection situation (step S1001). The conditions of the pre-pit detection situation and the data sync detection situation which are set in this step are used for judging the reliability of the recording deviation amount S5 to judge whether it is effective or noneffective according to the detection situations of the pre-pit sync signal S1 and the data sync detection signal S2, such as that the recording deviation amount S5 is enabled only when both of the pre-pit sync signal S1 and the data sync detection signal S2 are detected or when either of these signals is detected.

Next, the system controller 22 moves the pointer to the memory address where the recording deviation amount S5, the pre-pit detection situation S8, and the data sync detection situation S9 are firstly stored (step S1002), and judges whether or not the recording deviation amount S5 stored in the memory address exceeds the set threshold value and the pre-pit detection situation S8 and the data sync detection situation S9 satisfy the set conditions (step S1003). When the recording deviation amount S5 exceeds the threshold value and the pre-pit detection situation S8 and the data sync detection situation S9 satisfy the set conditions, the address on the optical disc 1 where the recording deviation occurs is specified based on the value of the pointer and the address on the optical disc 1 from which transfer of the recording deviation amount S5 is started, and the address and the recording deviation amount S5 are notified to the control unit (step S1004).

After the notification of the address where the recording deviation occurs and the recording deviation amount S5 (step S1004) is completed or when the result of judgment in step S603 is “NO”, it is judged whether or not the memory address pointed by the pointer is the final address where the value of the recording deviation amount S5 is stored (step S1005). When the memory address pointed by the pointer is not the final address, the pointer is advanced by one (step S1006), and the process returns to step S1003. When the memory address pointed by the pointer is the final address, the recording deviation confirming operation is ended. Further, it is possible to confirm the position on the optical disc where the recording deviation occurs and the recording deviation amount S5 by displaying the address and the recording deviation amount S5 which are notified to the control unit in step S1004 on a display unit (not shown) of the optical disc device.

As described above, according to the optical disc device of this second embodiment, similarly to the optical disc device of the first embodiment, since the recording deviation amount is calculated and transferred to the memory, the recording deviation which occurs on the optical disc can be directly confirmed without using a measurement device or the like, and thereby the man-hours for measuring the recording deviation amount can be significantly reduced. Further, it is possible to confirm whether a recording deviation which is specified in the standard occurs or not, as well as its occurrence position.

Furthermore, in the optical disc device of this second embodiment, the detection situations of the pre-pit sync signal and the data sync detection signal are transferred to the memory together with the recording deviation amount. Therefore, the detection situations of the pre-pit sync signal and the data sync detection signal can be used for the judgment as to whether a recording deviation outside the standard occurs or not, and thereby the reliability to the recording deviation judgment can be enhanced.

In the optical disc device 600 of this second embodiment, the jitter values of the reproduction clock and the recording clock may be measured by using circuits for measuring the jitters of the respective clocks which are provided in the stages subsequent to the reproduction clock generation circuit 11 and the recording clock generation circuit 20, respectively, and the measured jitter values may be input to the transfer data reception circuit 28. Thereby, the measured jitter values can be transferred to the memory 30 together with the recording deviation amount S5, the pre-pit detection situation S8, and the data sync detection situation S9, and the reliability of the measurement result of the recording deviation amount can be further enhanced.

### Embodiment 3

Next, an optical disc device according to a third embodiment of the present invention will be described with reference to the drawings.

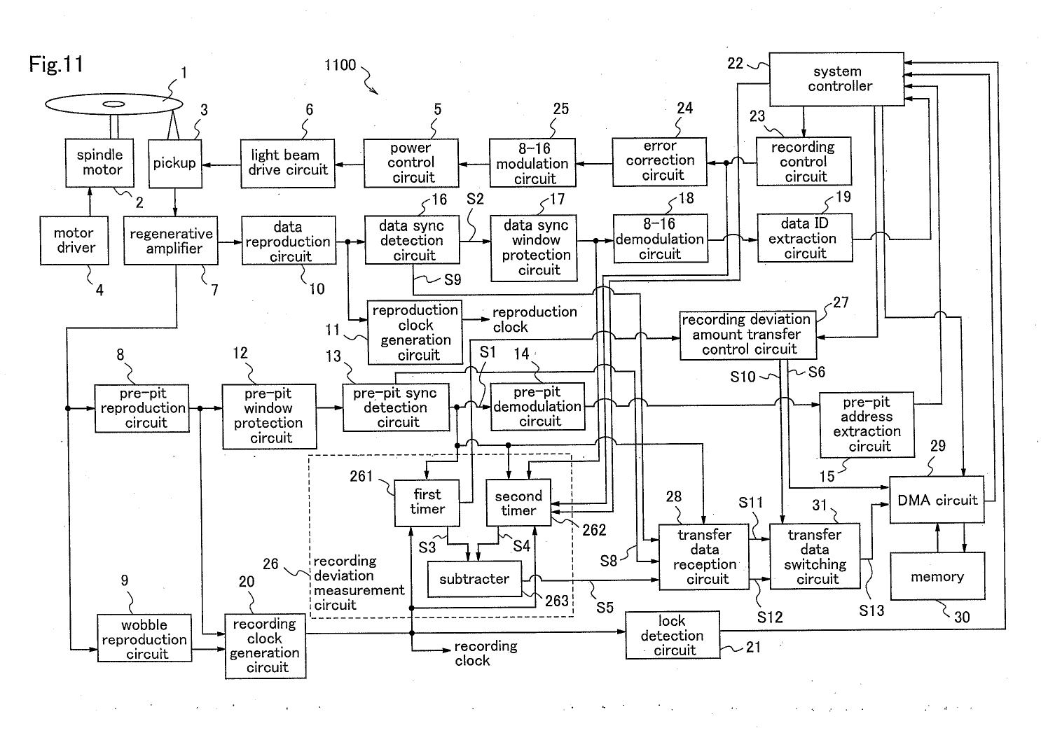

FIG. 11 is a block diagram illustrating an optical disc device 1100 of the third embodiment.

As shown in FIG. 11, the optical disc device 1100 of this third embodiment comprises an optical disc 1, a spindle motor 2, a pickup 3, a motor driver 4, a power control circuit 5, a light beam drive circuit 6, a regenerative amplification circuit 7, a pre-pit reproduction circuit 8, a wobble reproduction circuit 9, a data reproduction circuit 10, a reproduction clock generation circuit 11, a pre-pit window protection circuit 12, a pre-pit sync detection circuit 13, a pre-pit demodulation circuit 14, a pre-pit address extraction circuit 15, a data sync detection circuit 16, a data sync window protection circuit 17, a 8-16 demodulation circuit 18, a data ID extraction circuit 19, a recording clock generation circuit 20, a lock detection circuit 21, a system controller 22, a recording control circuit 23, an error correction circuit 24, a 8-16 modulation circuit 25, a recording deviation measurement circuit 26, a recording deviation amount transfer control circuit 27, a transfer data reception circuit 28, a DMA circuit 29, a memory 30, and a transfer data switching circuit 31.

In the optical disc device 1100 of this third embodiment, the transfer data reception circuit 28 receives the recording deviation amount S5 outputted from the subtracter 263, the pre-pit detection situation S8 outputted from the pre-pit sync detection circuit 13, and the data sync detection situation S9 outputted from the data sync detection circuit 16, and outputs the recording deviation amount S5 as transfer data 0_S11 and the pre-pit detection situation S8 and the data sync detection situation S9 as transfer data 1_S12 to the transfer data switching circuit 31, respectively.

On receipt of the recording deviation amount transfer instruction from the system controller 22, the recording deviation amount transfer control circuit 27 decodes the value of the first timer 261, and generates a recording deviation amount transfer timing signal S6 at the timing when the value of the first timer 261 is sufficiently apart from the value at which the first timer 261 is preset by the pre-pit sync signal S1 and at the timing a predetermined period after the above-mentioned timing.

Further, the recording deviation amount transfer control circuit 27 generates a transfer data selection signal S10 which instructs to switch the output S13 of the transfer data switching circuit 31 between the transfer data 0_S11 and the transfer data 1_S12. The signal level of the transfer data selection signal S10 is changed based on the recording deviation amount transfer timing signal S6. In this third embodiment, the transfer data selection signal S10 is switched between the H level and the L level at the timing of falling of the recording deviation amount transfer timing signal S6, and the transfer data 0_S11 is selected at the L level while the transfer data 1_S12 is selected at the H level.

The transfer data switching circuit 31 selects either of the transfer data 0_S11 or the transfer data 1_S12 which are outputted from the transfer data reception circuit 28, based on the transfer data selection signal S10, and outputs the selected data to the DMA circuit 29.

In FIG. 11, since the other constituents are identical to those of the first embodiment, repeated description is not necessary.

Next, the operation of the optical disc device 1100 configured as described above will be described.

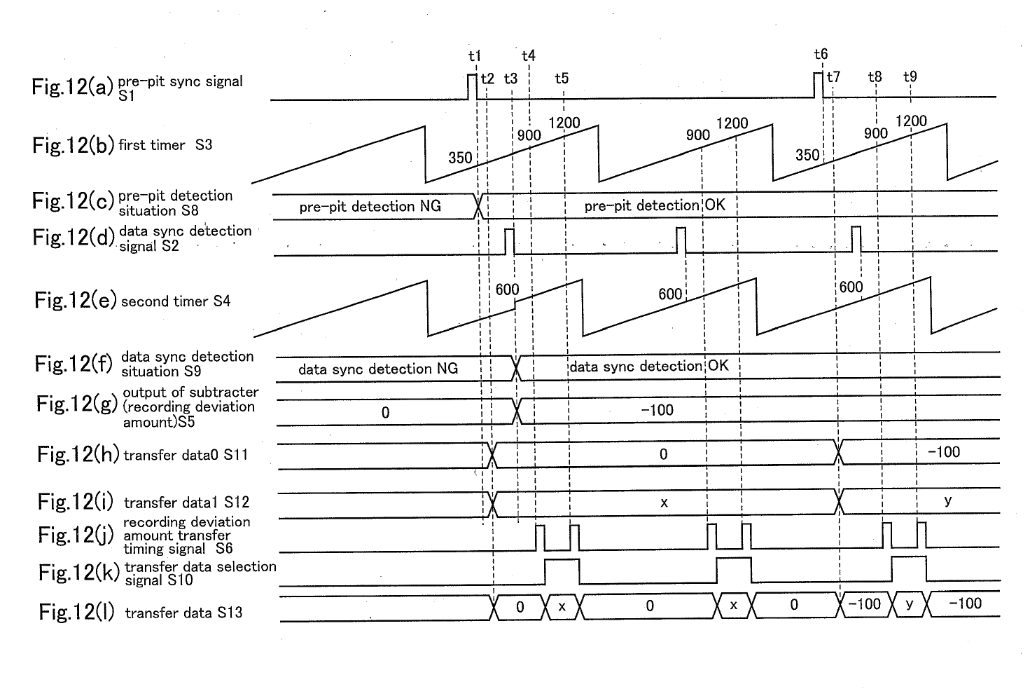

Initially, the recording deviation amount transfer operation will be described with reference to the timing chart shown in FIG. 12.

In FIG. 12, (a) shows the pre-pit sync signal S1, (b) shows the output S3 from the first timer 261, (c) shows the pre-pit detection situation S8, (d) shows the data sync detection signal S2, (e) shows the output S4 from the second timer 262, (f) shows the data sync detection situation S9, (g) shows the output S5 from the subtracter 263, (h) shows the transfer data 0_S11 outputted from the transfer data reception circuit 28, (i) shows the transfer data 1_S12 outputted from the transfer data reception circuit 28, (j) shows the recording deviation amount transfer timing signal S6, (k) shows the transfer data selection signal S10, and (l) shows the contents of the transfer data S13. In FIG. 12, “x” of the transfer data 1_S12 indicates the state where the pre-pit sync signal S1 is detected and the data sync detection signal S2 is not detected, and “y” of the transfer data 1_S12 indicates the state where the pre-pit sync signal S1 is detected and the data sync detection signal S2 is detected.

Initially, when the pre-pit sync signal S1 is input to the first timer 261, the first timer 261 is preset to a predetermined preset value at timing t1. The outputs from the first timer 261 and the second timer 262 are input to the subtracter 263, and the subtracter 263 performs subtraction between the value S3 of the first timer 261 and the value S4 of the second timer 262, and outputs the recording deviation amount S5 “0” to the transfer data reception circuit 28. Further, the pre-pit detection situation S8 indicating that the pre-pit sync signal S1 is detected is outputted from the pre-pint sync detection circuit 13 to the transfer data reception circuit 28, and the data sync detection situation S9 indicating that the data sync detection signal S2 is not yet detected is outputted from the data sync detection circuit 16 to the transfer data reception circuit 28.

The recording deviation amount S5, the pre-pit detection situation S8, and the data sync detection situation S9 are received by the transfer data reception circuit 28 at timing t2 which is one cycle after the outputting of the pre-pit sync signal S1, and the recording deviation amount S5 is outputted as the transfer data 0_S11 to the transfer data switching circuit 31 while the pre-pit detection situation S8 and the data sync detection situation S9 are outputted to the transfer data switching circuit 31 as the transfer data 1_S12.

Next, when the data sync detection signal S2 is input to the second timer 262, the second timer 262 is preset to a predetermined preset value at timing t3, and the recording deviation amount S5 outputted from the subtracter 263 becomes “−100” as shown in FIG. 12. Further, the data sync detection situation S9 outputted from the data sync detection circuit 16 indicates that the data sync detection signal S2 is detected.

When the recording deviation amount transfer timing signal S6 is generated at timing t4, the transfer data selection signal S10 becomes H level at the timing when the recording deviation amount transfer timing signal S6 falls, and thereby the output S13 of the transfer data switching circuit 13 is switched to the transfer data 1_S12 which is indicated by “x” in the figure. Then, this transfer data S13 “x” is written in the memory 30 by the DMA circuit 29. Thereafter, the write address in the memory 30 is advanced by one.

Next, when the recording deviation amount transfer timing signal S6 is generated at timing t5, the transfer data selection signal S10 becomes L level at the timing when the recording deviation amount transfer timing signal S6 falls. Thereby, the output S13 of the transfer data switching circuit 31 is switched to the transfer data 0_S11 which is indicated by “0” in the figure, and the transfer data S13 “0” is written in the memory 30 by the DMA circuit 29. Thereafter, the write address in the memory 30 is advanced by one. In this way, the recording deviation amount S5, and the detection situations of the pre-pit sync signal S1 and the data sync detection signal S2 are transferred to the memory 30 at the different timings, respectively.

Thereafter, the pre-pit sync signal S1 is outputted at timing t6. Then, at timing t7 which is one cycle after timing t6, the recording deviation amount S5 “−100” outputted from the subtracter 263, the pre-pit detection situation S8 indicating that the pre-pit sync signal S1 is detected, which is outputted from the pre-pit sync detection circuit 13, and the data sync detection situation S9 indicating that the data sync detection signal S2 is detected, which is outputted from the data sync detection circuit 16, are received by the transfer data reception circuit 28, and the recording deviation amount S5 is outputted as the transfer data 0_S11 and the pre-pit detection situation S8 and the data sync detection situation S9 are outputted as the transfer data 1_S12 to the transfer data switching circuit 31, respectively.

When the recording-deviation amount transfer timing signal S6 is generated at timing t8, the output S13 of the transfer data switching circuit 31 is switched to the transfer data 1_S12 which is indicated by “y” in the figure, and this transfer data S13 “y” is written in the memory 30 by the DMA circuit 29. Further, when the recording deviation amount transfer timing signal S6 is generated at timing t9, the output S13 of the transfer data switching circuit 31 is switched to the transfer data 0_S11 which is indicated by “−100” in the figure, and this transfer data S13 “−100” is written in the memory 30 by the DMA circuit 29.

Thereafter, the above-described operation is carried out and the value of the transfer data S13 is stored in the memory 30 until the system controller 22 receives the recording deviation amount transfer end instruction.

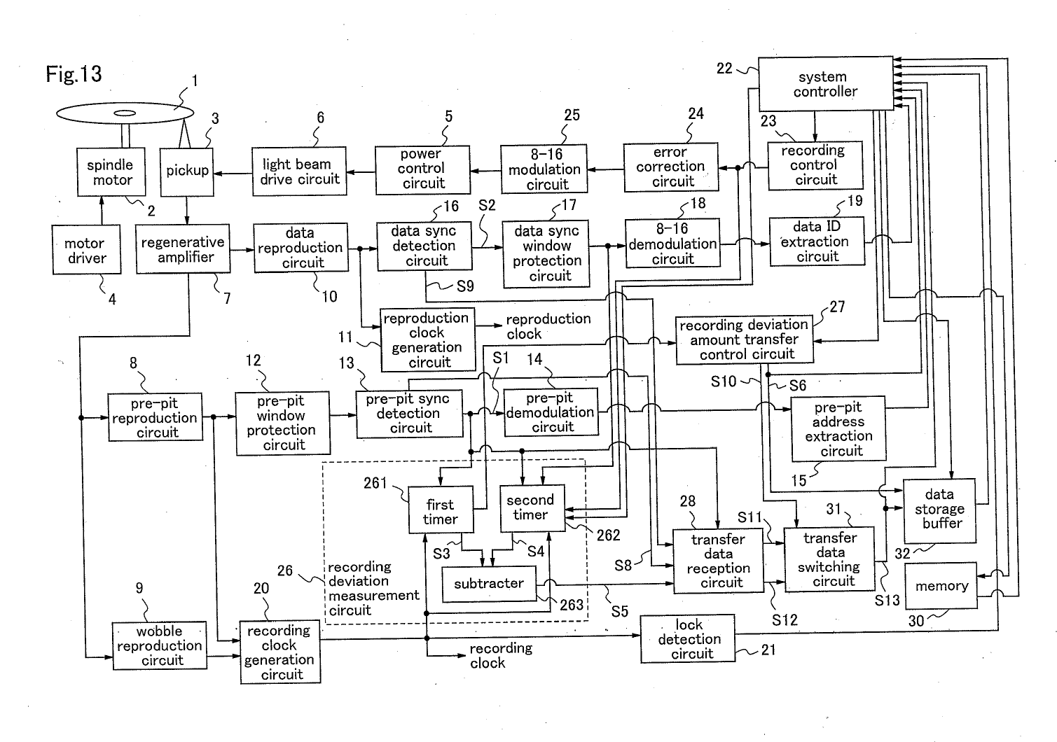

While in the above-described optical disc device 1100 data transfer is performed by the DMA circuit 29, data transfer can be performed without using the DMA circuit 29 by that, as shown in FIG. 13, the recording deviation amount transfer timing signal S6 is input to the system controller 22 as an interruption signal, and when the interruption signal is inputted, the system controller 22 receives the transfer data S7 from the transfer data reception circuit 28 and transfers the same to a predetermined address in the memory 30. The interruption signal which activates data transfer may be a signal other than the recording deviation amount transfer timing signal S6.

Further, when the output interval of the interruption signal is longer than the output interval of the recording deviation amount transfer timing signal S6, or when the number of interruptions is reduced to prevent the processing of the system controller 22 from being compressed due to frequent interruptions, or when the data transfer process after inputting of the interruption signal cannot be completed by the time the next recording deviation amount is obtained, it is possible to prevent the transfer data amount from being reduced by providing a data storage buffer 32 as shown in FIG. 13 to store the recording deviation amount in the data storage buffer 32.

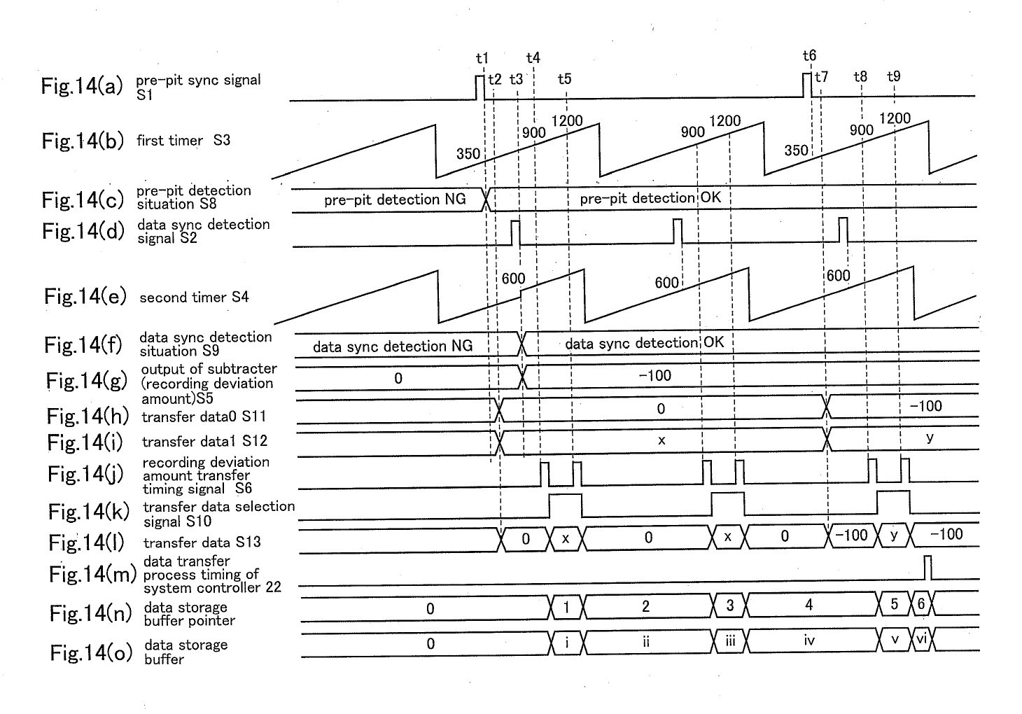

FIG. 14 is a diagram illustrating the operation timing when performing data transfer using the data storage buffer 32, and it shows the case where the system controller 22 transfers the transfer data S12 every time it receives the recording deviation amount transfer timing signals S6 six times.

In FIG. 14, (m) shows the data transfer process timing signal by the system controller 22. (n) shows the contents of a storage buffer pointer possessed by the data storage buffer 32. The data storage pointer controls the data storage position and shows the data amount required to be transferred when the system controller 22 transfers the data, and it is initialized when the data is transferred from the data storage buffer 32. (o) shows the contents of the data storage buffer 32, wherein i shows the state of holding the transfer data 0, ii shows the state of holding the transfer data 0,x, iii shows the state of holding the transfer data 0,x,0, iv shows the state of holding the transfer data 0,x,0,x, v shows the state of holding the transfer data 0,x,0,x,−100, and vi shows the state of holding the transfer data 0,x,0,x,−100, y.

As shown in FIG. 14, the value of the data storage buffer pointer and the contents of the data in the data storage buffer 32 are updated every time the recording deviation amount transfer timing signal S6 is outputted. When the sixth recording deviation amount transfer timing signal S6 is outputted, the system controller 22 receives the transfer data vi from the data storage buffer 32, and transfers the same to the predetermined address in the memory 30.

Thereby, it is possible to prevent the transfer data amount from being reduced even when the number of data transfers is reduced with respect to the number of interruptions.

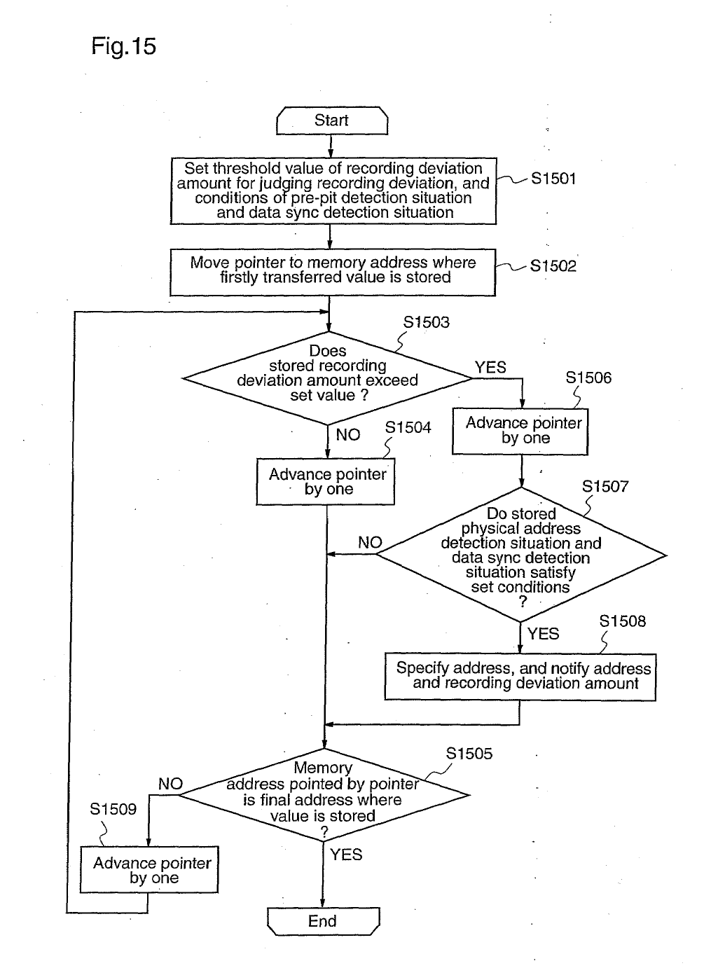

Next, the operation of judging whether a recording deviation outside the standard occurs or not will be described with reference to a flowchart shown in FIG. 15.

Initially, the control unit (not shown) which instructs the recording deviation amount confirming operation sets, on the system controller 22, the threshold value of the recording deviation amount for judging that a recording deviation occurs, and the conditions of the pre-pit detection situation and the data sync detection situation (step S1501). The conditions of the pre-pit detection situation and the data sync detection situation which are set in step S1501 are identical to those described in the second embodiment.

Next, the system controller 22 moves the pointer to the memory address where the recording deviation amount S5 is firstly stored (step S1502), and judges whether the stored recording deviation amount exceeds the set threshold value or not (step S1503).

When the recording deviation amount stored in the memory address does not exceed the threshold value, the pointer is advanced by one (step S1504), and the process goes to the step of judging whether or not the memory address pointed by the pointer is the final address which stores the value (step S1505). On the other hand, when the recording deviation amount exceeds the threshold value, the pointer is advanced by one (step S1506), and it is judged whether or not the pre-pit detection situation and the data sync detection situation satisfy the set conditions (step S1507).

When the set conditions are not satisfied as the result of the judgment in step S1507, the process goes to the step of judging whether or not the memory address pointed by the pointer is the final address which stores the value (step S1505). On the other hand, when the set conditions are satisfied, the address where the recording deviation occurs is specified from the value of the pointer and the address where the transfer of the recording deviation amount is started, and the address and the recording deviation amount are notified to the control unit (step S1508).

After the notification of the address where the recording deviation occurs and the recording deviation amount S5 (step S1508) is completed or after the judgment is “NO” in step S1503 and the pointer is advanced by one in step S1504, the process goes to the step of judging whether or not the memory address pointed by the pointer is the final address which stores the value (step S1505). When the memory address pointed by the pointer is not the final address, the pointer is advanced by one (step S1509), and the process returns to the step of judging whether the stored recording deviation amount exceeds the set threshold value or not (step S1503). When the memory address pointed by the pointer is the final address, the recording deviation confirmation operation is ended. The position on the optical disc where the recording deviation occurs as well as the recording deviation amount S5 can be confirmed by displaying the address and the recording deviation amount S5 which are notified to the control unit in step S1508 on a display unit (not shown) of the optical disc device.

As described above, according to the optical disc device of this third embodiment, similarly to the optical disc device of the first embodiment, since the recording deviation amount is calculated and transferred to the memory, the recording deviation which occurs on the optical disc can be directly confirmed without using a measurement device or the like, and thereby the man-hours required for measuring the recording deviation amount can be significantly reduced. Further, it is possible to confirm whether a recording deviation which is specified in the standard occurs or not, as well as its occurrence position.

Furthermore, similarly to the optical disc device of the second embodiment, since the detection situations of the pre-pit sync signal and the data sync detection signal are also transferred to the memory in addition to the recording deviation amount, the detection situations of the pre-pit sync signal and the data sync detection signal can be used for the judgment as to whether a recording deviation outside the standard occurs or not, and thereby the reliability of the recording deviation judgment can be enhanced.

At this time, since the detection situation of the pre-pit sync signal and the detection situation of the data sync detection signal are transferred to the memory at the timing different from the timing of transferring the recording deviation amount, the entirety of the data length which can be transferred at one time can be used for the transfer of the recording deviation amount, and thereby the recording detection amount can be detected without degrading the recording deviation amount measurement precision, as compared with the method of the second embodiment which transfers these detection situations simultaneously with the recording deviation amount.

In the optical disc device 1100 of this third embodiment, the jitter values of the reproduction clock and the recording clock may be measured by using circuits for measuring the jitters of the respective clocks which are provided in the stages subsequent to the reproduction clock generation circuit 11 and the recording clock generation circuit 20, respectively, and the measured jitter values may be input to the transfer data reception circuit 28. When transferring the measured jitter values to the memory 30, the measured jitter values may be transferred as the transfer data 0 together with the recording deviation amount S5 and thereby the jitter values can be transferred to the memory 30 at the timing different from the timings for the pre-pit detection situation S8 and the data sync detection situation S9, or the measured jitter values may be transferred as the transfer data 1 together with the pre-pit detection situation S8 and the data sync detection situation S9 and thereby the jitter values can be transferred at the timing different from the timing for the recording deviation amount S5, or only the measured jitter values may be transferred as the transfer data m and thereby the jitter values can be transferred at the timing different from the timings for the recording deviation amount S5, the pre-pit detection situation S8, and the data sync detection situation S9. Thus, the reliability of the recording deviation amount measurement result can be further enhanced.

In the above-described first to third embodiments, the optical disc 1 may be DVD+R or DVD+RW. In this case, the same functions and effects as those of the first to third embodiments can be obtained by detecting ADIP (Address In Pre-groove) as a physical address.

### APPLICABILITY IN INDUSTRY

The present invention is useful in that confirmation as to whether a DVD±R/RW disc is recorded so as to satisfy the disc standard or not can be executed without using a measurement device such as an oscilloscope.

1. An optical disc device comprising:
an address detection circuit which detects a physical address from an optical disc on which physical addresses are previously provided, and outputs a physical address detection signal;
a timer which is operated in synchronization with reproduced data from the optical disc;
a recording deviation amount measurement circuit which measures a recording deviation amount of data recorded in the optical disc, using the physical address detection signal and the count value of the timer;
a data transfer circuit which transfers the recording deviation amount to a memory; and
said memory which stores the recording deviation amount transferred from the data transfer circuit.

2. An optical disc device as defined in claim 1 further including
a transfer control system which controls the data transfer timing by the data transfer circuit, and
said data transfer circuit transferring information which indicates the detection situation of the physical address and information which indicates the synchronization state with the reproduced data, to the memory at the same timing as the timing for transferring the recording deviation amount.

3. An optical disc device as defined in claim 1 further including
a transfer control system which controls the data transfer timing by the data transfer circuit, and
said data transfer circuit transferring information which indicates the detection situation of the physical address and information which indicates the synchronization state with the reproduced data, to the memory at a timing different from the timing for transferring the recording deviation amount.

4. An optical disc device as defined in claim 1 further including
a judgment circuit which compares the recording deviation amount stored in the memory with a predetermined threshold value, judges that a recording deviation of the recorded data occurs when the recording deviation amount stored in the memory is equal to or larger than a predetermined amount, and specifies an address on the optical disc where the recording deviation occurs.

5. An optical disc device as defined in claim 3 further including
a judgment circuit which compares the recording deviation amount stored in the memory with a predetermined threshold value, judges that a recording deviation of the recorded data occurs when the recording deviation amount stored in the memory is equal to or larger than a predetermined amount, and specifies an address on the optical disc where the recording address occurs.

6. An optical disc device as defined in claim 2 further including
a judgment circuit which compares the recording deviation amount stored in the memory with a predetermined threshold value, judges whether the detection situation of the physical address and the synchronization state with the reproduced data satisfy predetermined conditions or not, determines that a recording deviation of the recorded data occurs when the recording deviation amount stored in the memory is equal to or larger than a predetermined amount and the detection situation of the physical address and the synchronization state with the reproduced data satisfy the predetermined conditions, and specifies an address on the optical disc where the recording deviation occurs.

7. An optical disc device as defined in claim 3 further including
a judgment circuit which compares the recording deviation amount stored in the memory with a predetermined threshold value, judges whether the detection situation of the physical address and the synchronization state with the reproduced data satisfy predetermined conditions or not, determines that a recording deviation of the recorded data occurs when the recording deviation amount stored in the memory is equal to or larger than a predetermined amount and the detection situation of the physical address and the synchronization state with the reproduced data satisfy the predetermined conditions, and specifies an address on the optical disc where the recording deviation occurs.

8. An optical disc device as defined in claim 2 further including
a jitter detection circuit which measures a jitter value of a clock used for detection of the physical address, and a jitter value of a clock used for detection of the reproduced data, and
said jitter values detected by the jitter detection circuit being transferred to the memory at the same timing as the timing for transferring the recording deviation amount.

9. An optical disc device as defined in claim 3 further including
a jitter detection circuit which measures a jitter value of a clock used for detection of the physical address, and a jitter value of a clock used for detection of the reproduced data, and
said jitter values detected by the jitter detection circuit being transferred to the memory at a timing different from the timing for transferring the recording deviation amount.

10. An optical disc device as defined in claim 9 further including
a jitter detection circuit which measures a jitter value of a clock used for detection of the physical address, and a jitter value of a clock used for detection of the reproduced data, and
said jitter values detected by the jitter detection circuit being transferred to the memory at the same timing as the timing for transferring the information indicating the detection situation of the physical address and the information indicating the synchronization state with the reproduced data.

11. An optical disc device as defined in claim 1 wherein said data transfer circuit is a DMA circuit.

12. An optical disc device as defined in claim 1 wherein said optical disc is a DVD-R or a DVD-RW, and said physical address is LPP (Land-Pre-Pit).

13. An optical disc device as defined in claim 1 wherein said optical disc is a DVD-R or a DVD-RW, and said physical address is ADIP (Address In Pre-groove).

14. A recording deviation amount transfer method comprising:
an address detection step of detecting a physical address from an optical disc on which physical addresses are previously provided, and outputting a physical address detection signal;
a count value measurement step of measuring a count value which is synchronized with reproduced data from the optical disc;
a recording deviation amount measurement step of measuring a recording deviation amount of data recorded on the optical disc by using the physical address detection signal and the count value measured in the count value measurement step;
a data transfer step of transferring the recording deviation amount to a memory; and
a data storage step of storing the recording deviation amount in the memory.
